(19) United States
(12) Patent Application Publication
(10) Pub. No.: US 2018/0121875 A1
(43) Pub. Date: May 3, 2018

(54) DELIVERY PREDICTION AUTOMATION AND RISK MITIGATION

(71) Applicant: Amazon Technologies, Inc., Seattle, WA (US)

(72) Inventors: Raghuram Satyanarayana Rao, Seattle, WA (US); Alan Kipust, Mercer Island, WA (US)

(21) Appl. No.: 14/589,775

(22) Filed: Jan. 5, 2015

(51) Int. Cl. G06Q 10/08

(52) U.S. Cl. CPC G06Q 10/08355

(57) ABSTRACT

In some examples, a delivery service may receive a delivery assistance request associated with the delivery of a package to a customer address by a delivery associate. In response, the delivery service may send a delivery assistance response to a delivery associate device of the delivery associate. The delivery assistance response may include one or more instructions for the delivery associate to perform at the customer address. For instance, the instructions may include leaving the package unattended at the customer address, attempting a redelivery at a later date and/or time, or waiting a specified amount of time at the customer address. Further, the delivery service may determine the instructions based upon one or more factors, such as information associated with the customer address, the delivery package, and the delivery associate. For example, the delivery service may determine the instructions based on the probability of theft at the customer address and/or a replacement cost of the delivery package.

### BACKGROUND

In some cases, customers may not be available when delivery personnel arrive at customer addresses. As a result, delivery personnel are often confronted with deciding whether to leave delivery packages unattended at customer addresses or take an alternative action. Failure to make the proper decision may lead to unsatisfied customers and/or higher delivery costs. For example, if the delivery person decides to return to the customer address at a later date for a second delivery attempt, the customer may be disappointed with the untimely date of delivery. However, if the delivery person leaves the delivery package unattended, a delivery service or merchant may have to cover the cost of replacing a lost or stolen delivery package item.

Many delivery personnel determine whether to leave delivery packages unattended based upon an assessment of the safety of the delivery packages at the customer address. However, delivery personnel often are limited to subjective assessments of safety. In addition, delivery personnel often possess a limited scope of the factors that contribute to high costs for the delivery service, especially inexperienced delivery personnel that are unfamiliar with the geographic area of the customer address.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example framework for a delivery service that receives a delivery assistance request from a delivery associate device according to some implementations.

FIG. 2 illustrates an example environment for a delivery service according to some implementations.

FIG. 3 illustrates example user interfaces for presenting route information or other information to a delivery associate according to some implementations.

FIG. 4 illustrates an example user interface for presenting delivery assistance or other information to a delivery associate according to some implementations.

FIG. 5 illustrates an example user interface for entering a wait time and/or a delivery location at a customer address according to some implementations.

FIG. 6 is an example flow diagram of a process for providing delivery assistance to a delivery associate according to some implementations.

FIG. 7 illustrates an example framework for a delivery service according to some implementations.

FIG. 8 is an example flow diagram of a process for providing return assistance to a customer according to some implementations

FIG. 9 illustrates an example delivery service computing device according to some implementations.

FIG. 10 illustrates an example delivery associate device according to some implementations.

FIG. 11 illustrates an example customer device according to some implementations.

### DETAILED DESCRIPTION

Some implementations described herein include techniques and arrangements for providing an automated delivery assistance service to instruct delivery associates on tasks to perform during a delivery attempt. As used herein, a delivery associate may include an employee, device, agent, or contractor of a delivery service. As used herein, a delivery service may include a service provider that delivers a delivery package to a customer and/or retrieves a return package from a customer. For example, a delivery associate employed by a delivery service may arrive at a customer address with a delivery package to deliver to a customer. In some cases, there may not be a person authorized to receive the delivery package present at the customer address. As a result, the delivery associate may use a delivery associate device to request assistance from a delivery assistance service. In response, the delivery assistance service may determine one or more tasks the delivery associate should perform based on a decision model. Further, the delivery assistance service may send a reply message to the delivery associate device including the one or more tasks. For instance, the reply message may instruct the delivery associate to leave the delivery package at the doorstep of the customer address, return for a redelivery attempt at a later date and/or time, or wait a specified amount of time to gain access to the customer address.

The delivery service may manage delivery orders within a delivery system. For example, the delivery service may receive a delivery order to deliver an item to a customer. The delivery order may include an item identifier of the item, a customer name (e.g., name, business name, etc.), and a customer address specifying a delivery destination for the item. Further, the delivery service may assign the delivery order to a delivery associate. In response, the delivery associate may retrieve a delivery package including the item associated with the delivery order from a storage facility. In addition, the delivery associate may deliver the delivery package to the customer address identified in the delivery order.

In some examples, the delivery service may manage route information associated with one or more delivery associates. As used herein, route information may include delivery package identifiers, directions for delivering delivery packages to customer addresses, traffic information associated with the directions, delivery orders corresponding to the delivery packages, optimal times of delivery for the individual delivery packages, and estimated times of delivery for the individual delivery packages.

Further, the delivery service may send the route information to a delivery associate device associated with the delivery associate. In addition, the delivery service may update the route information based upon traffic events and/or to accommodate instructions issued by the delivery service. For example, the delivery service may modify the route information based in part on traffic proximate to the one or more customer addresses included in the route information. In another example, the delivery service may modify the route information based in part on the addition of a redelivery attempt by the delivery service.

Further, the delivery service may instruct a delivery associate to wait a specified amount of time to gain access to the customer address based upon the route information. For instance, the delivery service may determine based upon traffic information that the delivery associate can wait a specified amount of time at a customer address and perform the remaining deliver attempts in accordance with the optimal times of delivery.

In some examples, the delivery service may manage weather information associated with one or more geographic regions. Further, the delivery service may determine whether to leave a package unattended at a customer address based on weather information. In addition, the delivery service may determine a location at the customer address to drop off a delivery item based on the weather information. For example, the delivery service may determine that the delivery item cannot be left unattended at an exterior location of the building based upon the likelihood of precipitation. In another example, the delivery service may determine that a weather forecast indicates that it will be unlikely that a delivery associate will be able to perform a redelivery attempt within a specified period of time. In response, the delivery service may instruct the delivery associate to leave the package unattended at the customer address to avoid an untimely delivery.

In some examples, the delivery service may manage an item database. The item database may include a monetary value and/or replacement attributes associated with individual items. For example, the monetary value may include the cost of the item, the replacement cost of the item, the sales price of the item, the manufacturer suggested retail price of the item, etc. Further, the replacement attributes may include an amount of a particular item in possession of the delivery service or a merchant associated with the delivery service, and/or data indicating previous incidents of theft or loss of the item. In some cases, the delivery service may instruct a delivery associate to redeliver a delivery package at a later date when the item of the delivery package has a high monetary value and/or replacement attributes that indicate it will be difficult to replace the item of the delivery package in a reasonable period of time.

In some examples, the delivery service may manage locale information associated with one or more geographic regions. The locale information may include crime and/or theft data within the geographic region, foot traffic information, business practice (e.g., customs and/or norms associated with the locale), seasonality and/or locale type (e.g., residential, commercial, etc.). Further, the delivery service may segment the locale information by country, region, state, county, zip code, neighborhood, community, block, etc.

In addition, the delivery service may determine to leave a package unattended at a customer address based on the locale information. For instance, the delivery service may determine one or more locales associated with a customer address. Further, the delivery service may determine theft data associated with the one or more locales. In some instances, the delivery service may instruct a delivery associate to leave a delivery package unattended at the customer address when the theft data indicates that the risk of loss of the delivery package is below a predetermined threshold. In some other instances, the delivery service may instruct a delivery associate to attempt to redeliver the delivery item at a later date and/or time based in part on a business practice associated with the one or more locales. For example, the locale information may indicate that the next day is a holiday. In response, the delivery service may instruct the delivery associate to make a redelivery attempt before the holiday. Additionally, or alternatively, the delivery service may instruct the delivery associate to make a redelivery attempt during the holiday given a higher probability that a person authorized to receive the delivery package will be present at the customer address.

As another example, the locale information may indicate customary hours of operations for local businesses. In response, the delivery service may instruct the delivery associate to make a redelivery attempt during the hours of operation. In yet another example, locale information may indicate that a signature confirmation is legally required for delivery packages having certain characteristics. In response, the delivery service may instruct the delivery associate to continue to make redelivery attempts until a person authorized to receive the delivery package is available to confirm the delivery of the delivery package.

In some examples, the delivery service may receive device activity associated with a plurality of customer devices, and may associate the device activity with particular customer profiles. Further, the delivery service may use a customer profile to determine the likelihood that a customer associated with the customer profile is currently available at a specific customer address. In addition, the delivery service may use a customer profile to determine the likelihood that a customer associated with the customer profile will be arriving at a specific customer address within a specified amount of time.

In some cases, the delivery assistance service may instruct a delivery associate to continue attempting to contact the customer when the customer activity information indicates that it is probable the customer is available at the customer address. In some other cases, the delivery assistance service may instruct a delivery associate to wait a specified amount of time when the customer activity information indicates that it is probable an occupant of the customer address will be available at the customer address within a specified amount of time.

Further, the delivery service may receive delivery feedback information from a plurality of customers, and may associate the delivery feedback with particular customer address profiles and/or item information. Delivery feedback information may include data indicating a delivery attempt was successful, a rating of the timeliness of a delivery, a rating of the condition of the product upon delivery, and/or a rating of the effectiveness of the packaging of the delivery package.

For instance, one or more customers residing at a customer address may send delivery feedback indicating that the customers have not received delivery packages left unattended at an exterior location of the customer address by delivery associates. In response, the delivery service may update the customer address profile corresponding to the customer address to indicate that the delivery packages were lost or stolen when left unattended at the exterior location of the customer address.

Further, the delivery service may determine the likelihood that a delivery package left unattended at the exterior location will be lost or stolen based upon the customer address profile. Thus, the delivery service may instruct delivery associates delivering delivery packages to the customer address to wait a specified amount of time to gain access to the customer address in order to leave the delivery packages at an interior location of the building and/or to attempt to redeliver the delivery packages at a later date and/or time.

In some other instances, the delivery service may receive negative feedback from customers that have received similar items in a delivery package. The negative delivery feedback may indicate that the condition of the item upon delivery was unsatisfactory. In response, the delivery service may update the item database to indicate that delivery associates have delivered the item in an unsatisfactory condition. Further, the delivery service may determine that the item be delivered in a more protective packaging based upon the item database.

In addition, the delivery service may receive delivery associate information from a plurality of delivery associate devices, and may associate the delivery associate information with particular customer address profiles. For example, the delivery associate information may include a history of time spent waiting for access to the customer address during previous delivery attempts to the customer address. In response, the delivery service may update a customer address profile corresponding to the customer address to include a history of time spent waiting for access to the customer address during previous delivery attempts to the customer address. Further, the delivery service may determine that a delivery associate should wait at a customer address based on previous wait times included in the customer address profile corresponding to the customer address. In addition, the delivery service may determine an amount of time a delivery associate should wait at the customer address based on wait times included in the customer address profile corresponding to the customer address.

The delivery associate information may further include a description of the building at the customer address. For example, the delivery associate can include the type of building at the customer address (e.g., single, family, multi-family, apartment building, etc.), and/or one or more locations of the building available for delivery package drop-off (e.g., front steps, front porch, mailbox, back porch, front desk, doorman, etc.). In response, the delivery service may update a customer address profile corresponding to the customer address to include the type of building at the customer address and/or one or more locations of the building at the customer address available for delivery package drop-off. Further, the delivery service may determine a location for a delivery associate to drop-off the delivery item based upon the building type and/or the drop-off locations included in the customer profile.

Further, the delivery associate information may include delivery confirmation information. Delivery confirmation information may include identifiers of one or more delivery packages, the date and time of the delivery of the delivery packages, and/or a type of delivery (unattended drop off, received by authorized person, signature confirmation, etc.). In addition, the delivery confirmation information may include the location of an unattended drop off of a delivery package performed by a delivery associate

Further, the delivery service may update a customer address profile corresponding to the customer address to include the delivery confirmation information. In addition, the delivery service may use delivery feedback received from a customer to supplement the delivery confirmation information. For example, a customer may send a delivery feedback message confirming successful receipt of a delivery package. In response, the delivery service may modify the customer address profile to indicate that the delivery attempt was successful.

In addition, the delivery service may use the updated delivery confirmation information of the customer address profile to determine the likelihood that a delivery package may be lost or stolen when left unattended on a specific day of the week and/or time of the day. Further, the delivery service may use the updated delivery confirmation information of the customer address profile to determine the likelihood that a delivery package may be lost or stolen when left unattended at a specific location of the customer address.

In addition, the delivery associate information may further include traffic information. For instance, the delivery associate devices may include one or more sensors configured to collect traffic information. Further, the delivery associate devices may periodically send the traffic information to the delivery service. In addition, the delivery service may provide route information to delivery associates based at least in part on the traffic information.

In some examples, the delivery service may use a decision model to determine one or more tasks the delivery associate should perform upon arrival at a customer address with a delivery package. The decision model may determine the deliverability of a delivery package during each delivery attempt. In some examples, the deliverability may include the optimal risk of loss. Further, the deliverability may be based on at least one of the route information, weather information, item information, locale information, customer profiles, and customer address profiles.

For instance, the deliverability may be based on a replacement cost associated with an item of a delivery package, probability of loss or theft of the delivery package, cost of re-delivery of the delivery package by a delivery associate, cost of waiting at a customer address associated with the delivery package, and/or an estimated wait time until a safer delivery option is available at the customer address. For example, the decision model may compare the cost of attempting to redeliver a delivery package to the sum of the cost of a current delivery attempt and the probability of the delivery package being lost multiplied by a cost associated with delivery package. When the cost of attempting to redeliver the delivery package is less than or equal to the sum of the cost of the current delivery attempt and the probability of the delivery package being lost multiplied by a cost associated with the delivery package, the delivery assistance service may instruct the delivery associate to perform a redelivery attempt. When the cost of attempting to redeliver the delivery package is greater than or equal to the sum of the cost of a current delivery attempt and the probability of the delivery package being lost multiplied by a cost associated with delivery package, the delivery assistance service may instruct the delivery associate to leave the package unattended. Further, the decision model may take into account the probability of success of the redelivery attempt.

In some examples, the decision model may further include a trained statistical model that is initially trained using at least one of the route information, weather information, item information, locale information, customer profiles, and customer address profiles. In addition, the delivery service may periodically update and re-train the decision model based on new training data to keep the model up to date. For instance, the decision model may employ machine learning techniques to continuously train the statistical model as training data is collected. Further, the delivery service may modify or alter weights assigned to individual factors of the decision model.

In some examples, the delivery service may provide return package assistance to a customer. For example, a customer may be unsatisfied with an item received from the delivery service, and wish to return the item. As a result, the customer may use a customer device to send a return assistance request to the delivery service. In response, the delivery assistance service may determine one or more instructions that the customer should perform based on a decision model. Further, the delivery assistance service may send the instructions to the customer device. In some examples, the instructions may include leaving the delivery package at a location of a customer address or presenting the item to a delivery associate at a specified date and time.

For discussion purposes, some examples are described in the environment of delivery assistance and risk mitigation. However, the implementations herein are not limited to the particular examples provided, and may be extended to other types of environments, other types of electronic devices, and so forth, as will be apparent to those of skill in the art in light of the disclosure herein.

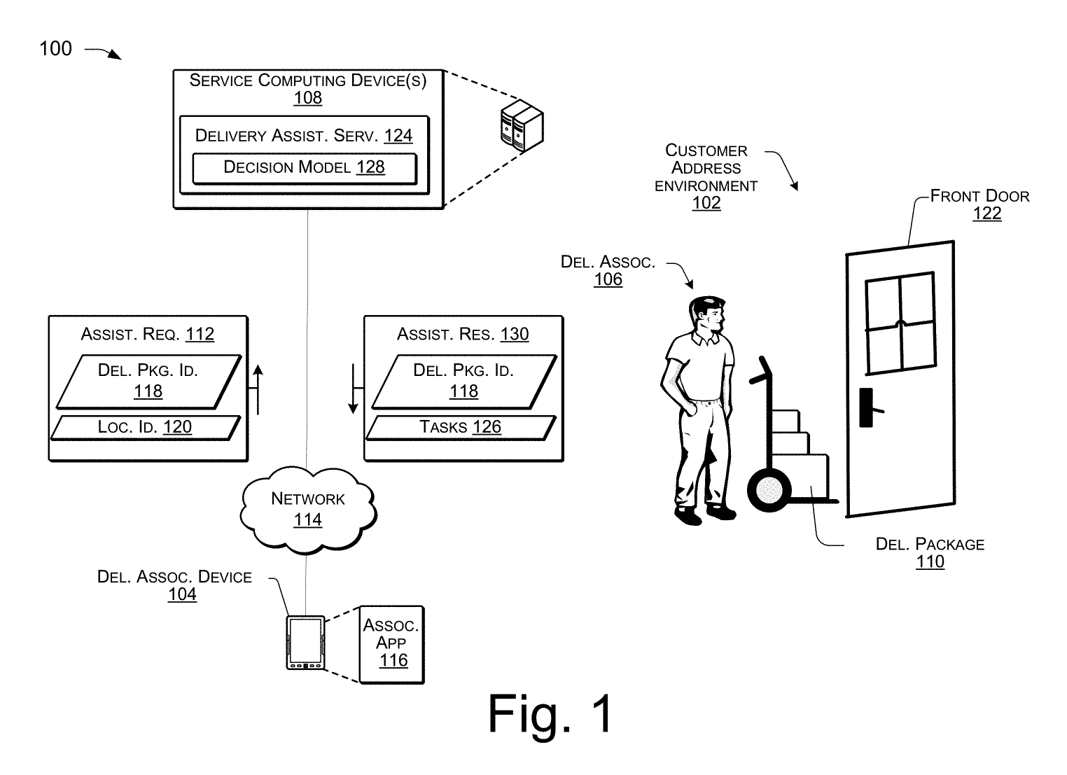

FIG. 1 illustrates an example framework 100 for a delivery service that provides delivery assistance to a delivery associate, according to some implementations. FIG. 1 shows illustrative interactions within a customer address environment 102 between a delivery associate device 104 associated with a delivery associate 106, and remote service computing devices of a delivery service 108 when performing various operations, including managing an attempt by the delivery associate 106 to deliver a delivery package 110 to the customer address environment 102. Some examples of the delivery associate device 104 may include smart phones and mobile devices; desktop, terminal and workstation computing devices; laptop and netbook computing devices; tablet computing devices; automotive electronic devices; and any other device capable of communicating with the delivery service 108.

In the illustrative example of FIG. 1, suppose the delivery associate 106 arrives at the customer address environment 102, and there are not any people authorized to receive the delivery package available at the customer address environment 102. In response, the delivery associate 106 may send a delivery assistance request 112 to the delivery service 108 via a network 114.

In some cases, the network 114 may be a publicly accessible network of linked networks, possibly operated by various distinct parties, such as the Internet. In other embodiments, the network 114 may include a private network, personal area network (“PAN”), local area network (“LAN”), wide area network (“WAN”), cable network, satellite network, etc. or some combination thereof, each with access to and/or from the Internet. For example, one or more computing devices associated with the delivery service 108 may be located within a single data center and may communicate via a private network.

In some examples, the delivery associate 106 may use a delivery associate application 116 installed on the delivery associate device 104 to send the delivery assistance request 112. Additionally, or alternatively, the delivery associate device 104 may access a website (e.g., a delivery service website) that offers functionality similar to the delivery associate application 116 via a web browser application. In some examples, the delivery assistance request 112 may include a delivery package identifier 118 that identifies the delivery package 110. Typically, but not necessarily, the delivery package 110 is tagged or otherwise marked with the delivery package identifier 118. For example, delivery package 110 may be marked or tagged with a bar code, 2D/3D bar code, Quick Response (QR) code, Near Field Communication (NFC) tag, Radio Frequency Identifier Device (RFID) tag, magnetic stripe, Universal Product Code (UPC), Stock-Keeping Unit (SKU) code, serial number, and/or other designation (including proprietary designations) that may be used as item identifiers 118 to facilitate fulfillment system operations. Further, the delivery assistance request 112 may include a location identifier 120 that identifies one or more locations in the customer address environment 102 currently available for dropping off the delivery package 110. For example, the location identifier 120 may indicate that the delivery associate 106 may leave the delivery package 110 unattended at the front door 122 of the customer address environment 102. In some examples, the location identifier 120 may be determined using a GPS sensor of the delivery associate device 104 and/or geo-tagging an IP address associated with the delivery associate device 104.

The delivery service 108 may receive the delivery assistance request 112 and provide the delivery assistance request 112 to a delivery assistance service 124. Further, the delivery assistance service 124 may determine one or more tasks 126 for the delivery associate 106 to perform within the customer environment 102 based on a decision model 128. For example, the tasks 126 may include an instruction for the delivery associate 106 to leave the delivery package 110 at the front door 122 of the customer environment 102. In another example, the tasks 126 may include an instruction for the delivery associate 106 to depart the customer environment 102, and attempt redelivery of the delivery package 110 at a later date and/or time.

Further, the decision model 128 may determine the one or more tasks 126 based at least in part on the delivery package identifier 118 and/or the location identifier 120. For example, the delivery service 108 may determine a customer address associated with the delivery package 110 based on the delivery package identifier 118. In addition, the decision model 128 may use the customer address to determine the probability of theft or loss of the delivery package 110 if left unattended at the customer address environment 102. As another example, the delivery service may determine a replacement cost associated with the delivery package 110 based on the delivery package identifier 118. Further, the decision model 128 may determine to leave delivery package 110 unattended at the customer address environment 102 based in part on the replacement cost. As still another example, the decision model 128 may use the location identifier 120 to determine the probability of theft or loss of the delivery package 110 if left unattended at a location associated with the location identifier 120.

Once the decision model 128 has determined the one or more tasks 126, the delivery assistance service 124 may send a delivery assistance response 130 to the delivery associate device 104. In some examples, the delivery assistance response 130 may include the delivery package identifier 118 and the tasks 126. Further, the delivery associate application 116 may display the tasks 126 to the delivery associate 106 on the delivery associate device 104. Additionally, and alternatively, the delivery associate application 116 may audibly communicate the tasks 126 to the delivery associate 106 via the delivery associate device 104

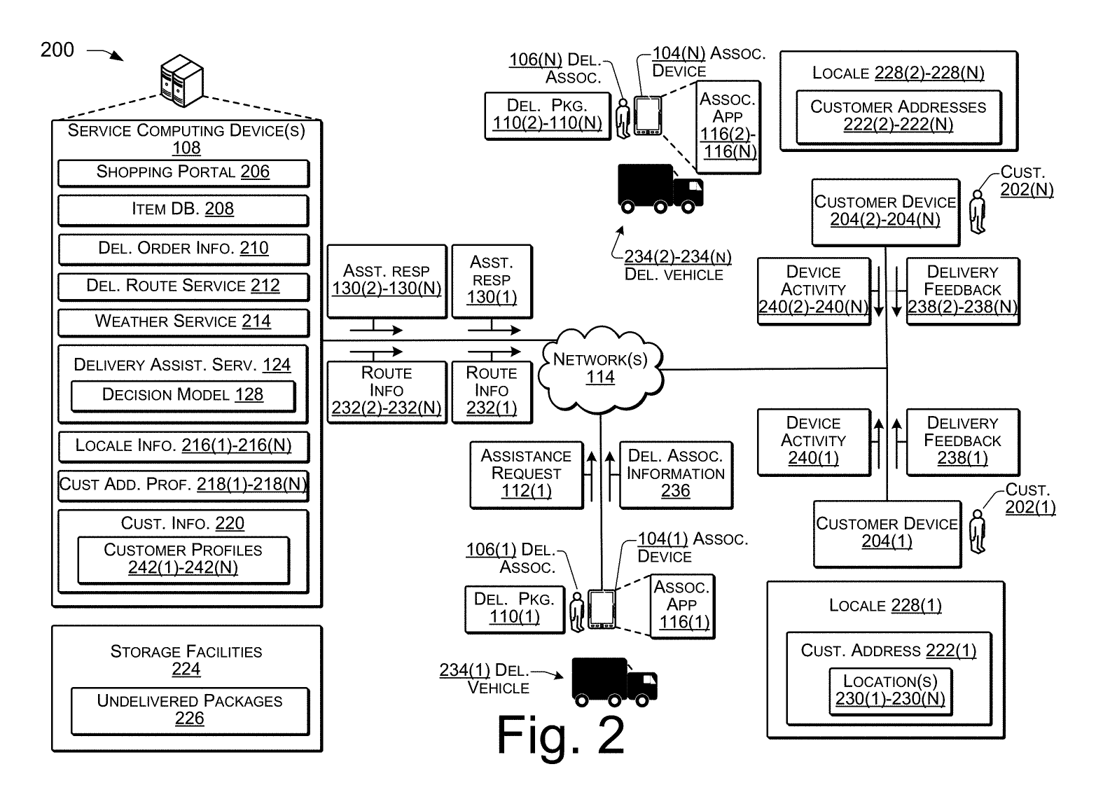

FIG. 2 illustrates an example environment 200 for a delivery service according to some implementations. FIG. 2 shows illustrative interactions between delivery associate devices 104, the delivery service 108, and customer devices 204, when performing various operations, including configuring the delivery assistance service 124 and providing delivery assistance to delivery associates 106 via the delivery assistance service 124.

In the illustrated example, the delivery associate devices 104 and the customer devices 204 are able to communicate with the delivery service 108 over the networks 114. Each delivery associate device 104 may be associated with a respective delivery associate 106. For example, a first delivery associate device 104(1) may be associated with a first delivery associate 106(1). Further, other delivery associates devices 104(2)-104(N) may be associated with other delivery associates 106(2)-106(N). Each customer device 204 may be associated with a respective customer 202. For example, one or more first customer devices 204(1) may be associated with a first customer 202(1). Further, other customer devices 204(2)-204(N) may be associated with other customers 202(2)-202(N).

As shown in FIG. 2, the delivery service 108 may include an online shopping portal 206, an item database 208, delivery order information 210, a delivery route service 212, a weather service 214, locale information 216, customer address profiles 218, and customer information 220. In addition, one or more online merchants may offer items for purchase, rental, lease or other consumption by the customers 202 via the online shopping portal 206 (e.g., websites, peer-to-peer systems, etc.). In some examples, the online shopping portal 206 may display items of the item database 208 for sale, rental, lease or other consumption via a website or an application.

The item database 208 may store item information for a plurality of items available for purchase at the online shopping portal 206, with each item associated with one or more item identifiers. In addition, the item database 208 may store one or more monetary values associated with individual items. In some examples, the monetary values may include the cost of the item, the replacement cost of the item, the sales price of the item, and/or the manufacturer suggested retail price of the item. Further, the item database 208 may store one or more replacement attributes associated with individual items. The replacement attributes may include an indicator of the scarcity of the item, a quantity of the item available for sale on the online shopping portal 206, and/or the location of the items available for sale on the online shopping portal 206. In addition, the item database 208 may include data representing previous incidents of theft or loss for individual items during delivery attempts by the delivery service 108. The item database 208 may further include related item information (e.g., description, packaging information, geographic restrictions, etc.) for each item.

When customers purchase (or alternatively, rent, lease or otherwise consume) items from the online shopping portal 206, the online shopping portal 206 may generate delivery order information 210 for each purchase. The delivery order information 210 may include an item identifier of the purchase item, a customer identifier of the purchasing customer 202, a customer address identifier that identifies a customer address 222, and the delivery package identifier 118. Each customer address 222 may be associated with a respective customer 202. For example, a first customer address 222(1) may be associated with a first customer 202(1). Further, other customer addresses 222(2)-222(N) may be associated with other customers 202(2)-202(N).

Further, the delivery service 108 may assign delivery orders to delivery associates 106. Once a delivery order has been assigned to a particular delivery associate 106, the particular delivery associate 106 may retrieve a delivery package 110 associated with the delivery order from one or more storage facilities 224. Some examples of storage facilities may include fulfillment centers, warehouses, delivery boxes, delivery lockers, and/or any storage space associated with the delivery service 108 and/or customer 202. Further, the delivery package 110 may include the items of the delivery order. The storage facilities 224 may further store undelivered packages 226 awaiting pick up by delivery associates 106. As described above, each delivery package 110 may be associated with a respective delivery associate 106. For example, a first delivery package 110(1) may be associated with a first delivery associate 106(1). Further, other delivery packages 110(2)-110(N) may be associated with other delivery associates 106(2)-106(N).

In addition, the delivery route service 212 may generate delivery routes for delivery associates 106 based upon the delivery order information 210. For instance, the delivery route service 212 may generate routes based on delivery orders assigned to the delivery associate 106. Each route may include the customer addresses 222 associated with the delivery orders assigned to a particular delivery associate 106, and directions to the customer addresses 222. In some examples, the route may include an ordered series of directions for the delivery associate 106. In some examples, the delivery route service 212 may generate delivery routes while taking into account information from the weather service 214, locale information 216, customer address profiles 218, customer information 220 or any other information, as described herein.

The weather service 214 may collect and distribute weather information associated with one or more geographic regions. In some examples, the weather service 214 may collect weather information from a plurality of weather sources. The weather sources may include the National Weather Service, National Oceanic and Atmosphere Administrations, and commercial weather providers. Further, the weather service 214 may build a weather forecast model configured to provide weather predictions based upon weather information collected from the weather sources.

The locale information 216 may include information associated with one or more locales 228. As used herein, a locale 228 may include all or any portion of any street, city, county, state, country, continent, region, or any other areas, including combinations or subsets of areas. Further, a locale 228 may include one or more customer addresses 222. For example, a first locale 228(1) may contain a first customer address 222(1), an Nth locale 228(N) may contain an Nth customer address 222(N), and so forth.

Further, the locale information 216 may include crime and/or theft data, foot traffic information, business practice (e.g., customs and/or norms associated with the locale), and/or locale type (e.g., residential, commercial, etc.). Further, locale information 216 may be segmented by locale 228. For example, the locale information 216 may be segmented by country, region, state, county, zip code, neighborhood, community, block, etc. For instance, the delivery service 108 may determine a business practice for a neighborhood. In another instance, the delivery service 108 may determine a business practice for a state including the neighborhood.

The customer address profiles 218 may include information related to the customer addresses 222. For example, a first customer address profile 218(1) may correspond to a customer address 222(1), an Nth customer address profile 218(N) may correspond to an Nth customer address 222(N), and so forth. The customer address profile 218 can include the type of building at the customer address 222, and one or more locations 230 at the customer address 222 available for delivery package receipt. Further, the customer address profile 218 may include theft and/or loss data corresponding to the customer address 222 and/or locations 230 of the customer address 222.

As shown in FIG. 2, the delivery route service 212 sends route information 232 to a delivery associate application 116. For example, first route information 232(1) may correspond to a first delivery associate application 116(1), the Nth route information 232(N) may be associated with an Nth delivery associate application 116(N), and so forth. The route information 232 may include delivery package identifiers 118, a route generated by the delivery route service 212, traffic information associated with the route, and delivery order information 210 associated with the delivery package 110. In some examples, the delivery associate 106 may use a delivery vehicle 234 to transport a delivery package 110 in accordance with the route information 232 to a customer address 222. Some examples of delivery vehicles 234 include cars, trucks, motorcycles, aircraft, watercraft, bicycles, or any other similar apparatus capable of conveyance that transports people and/or objects. In some cases, the delivery associate device may be embedded into the delivery vehicle 234. For example, the delivery associate device 104 may be a touch screen dashboard device installed in an automobile 234. Additionally, or alternatively, a delivery associate 106 may deliver delivery packages 110 on foot.

Once the delivery associate 106 arrives at the customer address 222(1), the delivery associate 106(1) may attempt to deliver the delivery package 110(1) to a person at the customer address 222(1). For instance, the delivery associate 106(1) may ring a doorbell at the customer address 222(1). As shown in FIG. 2, if the delivery associate is unable to get in contact with a person authorized to receive the delivery package 110(1), the delivery associate 106(1) may send a delivery assistance request 112(1) to the delivery service 108 via the delivery associate application 116(1).

Upon receipt of the delivery assistance request 112(1), the delivery assistance service 124 may determine one or more tasks 126 (not shown in FIG. 2) based in part on the decision model 128. Further, the delivery assistance service 124 may send the delivery assistance response 130(1) including the tasks 126 to the delivery associate device 104(1). In addition, the delivery associate application 116(1) may present the tasks 126 to the delivery associate 106(1) via a GUI interface of the delivery associate application 116(1).

In some examples, the tasks 126 may instruct the delivery associate 106(1) to leave the delivery package 110(1) unattended at the customer address 222(1), for example, at a particular location 230(1) of the customer address 222(1). In some other examples, the tasks 126 may instruct the delivery associate 106(1) to leave the delivery package 110(1) with a person authorized to receive the delivery package 110(1) at a location within a predetermined distance of the customer address 222. In some other examples, the tasks 126 may instruct the delivery associate 106(1) to attempt to redeliver the delivery package 110(1) at a later date and/or time. In some other examples, the tasks 126 may instruct the delivery associate 106(1) to obtain a signature confirmation of the delivery of the delivery package 110(1). In yet another example, the tasks 126 may instruct the delivery associate 106(1) to wait at the customer address 222(1) for a specified amount of time. Further, if the delivery associate 106(1) is unable to get in contact with a person authorized to receive the delivery package 110(1) before the specified time elapses, the tasks 126 may additionally instruct the delivery associate 106(1) to leave the delivery package 110(1) unattended or attempt to redeliver the delivery package 110(1) at a later date and/or time. In some other examples, the tasks 126 may instruct the delivery associate 106(1) to deliver the delivery package 110(1) to one of the storage facilities 224 or one of the other delivery associates 106(2)-106(N). For example, the tasks 126 may instruct the delivery associate 106(1) to deliver the delivery package 110(1) to a delivery locker 224 within a predetermined distance of the customer address 222. Further, the delivery service 108 may provide the customer 202(1) access to the delivery locker 224.

Further, the delivery associate 106(1) may send delivery associate information 236 to the delivery service 108 using the delivery associate application 116(1). The delivery associate information 236 may include an amount of time the delivery associate 106(1) spent waiting to gain access to the customer address 222(1). The delivery associate information 236 may further include a description of the building at the customer address 222(1). For example, the delivery associate information 236 can include the type of building at the customer address 222(1) (e.g., single family, multi-family, apartment building, etc.), and/or one or more locations 230(1) (e.g., front steps, front porch, mailbox, back porch, front desk, doorman, etc.) at the customer address 222(1) available for delivery item drop-off. Further, the delivery associate information 236 may include delivery confirmation information. Delivery confirmation information may include an identifier of the delivery package 110(1), the date and time of the delivery, and/or the drop-off location 230(1) of the delivery item at the customer address 222(1).

Upon receipt of delivery associate information 236, the delivery service 108 may update the delivery order information 210 to indicate that the delivery associate 106(1) has delivered the delivery package 110(1). Further, the delivery service 108 may associate the delivery associate information 236 with a customer address profile 218(1). For example, the delivery service 108 may update the customer address profile 218(1) to reflect that the delivery associate 106(1) had to wait five minutes before gaining access to the customer address 222(1). In another example, the delivery service 108 may update the customer address profile 218(1) to reflect that the customer address 222(1) had a doorman on site during the delivery attempt.

In some examples, the customers 202 may use the customer devices 204 to send delivery feedback 238 to the delivery service 108 after a delivery attempt by the delivery associates 106. For example, first delivery feedback 238(1) may correspond to the first customer 202(1), the Nth delivery feedback 238(N) may be associated with an Nth customer 202(N), and so forth. The delivery feedback 238 may include data indicating whether the delivery attempt was successful, a rating of the timeliness of the delivery, a rating of the condition of the item upon delivery, and/or a rating of the effectiveness of the packaging of the delivery package 110. In some examples, the delivery feedback 238 may include crowd sourced information provided by customers 202, such as information collected from message boards, comment sections, blogs, micro-blogs, forums and/or social networks.

Upon receipt of the delivery feedback 238, the delivery service 108 may update the delivery order information 210 to indicate whether the particular delivery associate 106 has successfully delivered the delivery package 110. Further, the delivery service 108 may associate the delivery feedback 238 with customer address profiles 218 and/or the locale information 216. For example, the delivery service 108 may update the customer address profile 218(1) to reflect that the delivery package 110(1) was lost or stolen. In another example, the delivery service may update the customer address profile 218(1) to reflect that the delivery package 110(1) was successfully delivered after being left unattended at a mailbox 230(1) of the customer address 222(1).

In some examples, the customer devices 204 may send device activity 240 to the delivery service 108. Further, the device activity 240 may include usage data and habit information associated with the customer device 204. For example, first device activity 240(1) may correspond to the first customer device 204(1), the Nth device activity 240 (N) may be associated with an Nth customer device 204(N), and so forth. For instance, the device activity 240 may include frequency of usage, time of usage, duration of usage, and locations of the customer device 204 during device usage. In some examples, the location of the customer device 204 may be determined using a GPS sensor of the customer device 204 and/or geo-tagging an IP address associated with the customer device 204.

Additionally, or alternatively, the device activity 240 may correspond to interaction between the customer device 204 and one or more services associated with the delivery service 108. For example, the device activity 240(1) may correspond to customer 202(1) activity at the online shopping portal 206. For instance, the device activity 240(1) may include data indicating that the customer 202(1) logged into the online shopping portal 206 at a specific date and time from the customer address 222(1).

The delivery service 108 may associate device activity 240 with customer information 220 maintained by the delivery service 108. For example, the first device activity 240(1) may be associated with a first customer profile 242(1) corresponding to the first customer 202(1), the Nth device activity 240(N) may be associated with an Nth customer profile 242(N) corresponding to an Nth customer 202(N), and so forth. For example, the delivery service 108 may update the customer profile 242(1) to reflect that the customer 202(1) device was in use from 3 pm to 5 pm at the customer address 222(1). In another example, the delivery service may update the customer profile 242(1) to reflect that the customer 202(1) logged onto the online shopping portal 206 at 9 am from the customer address 222(1).

The delivery assistance service 124 may train the decision model 128 using the information from the delivery route service 212, information from the weather service 214, locale information 216, customer address profiles 218, and/or customer profiles 242 as training data. As one example, the decision model 128 may include trained statistical models that account for numerous pieces of information including a customer address 222, locations 230 within the customer address 222, monetary values of delivery packages 110, replacement attributes, theft and loss statistics, crime statistics, route information 232 associated with one or more delivery associates 106 associated with the delivery packages 110, wait times associated with previous delivery attempts, a type or category of the customer 202, time of day of the delivery attempt, day of the week, seasonality, weather, etc. The statistical models may be initially trained using a set of training data, checked for accuracy, and then used for determining the optimal risk of loss of a delivery package 110, and determining whether to instruct a delivery associate 106 to leave the delivery package 110 unattended, leave without delivering the delivery package 110, or wait a specified of time for a person authorized to be available to receive the delivery package 110. The statistical models may be periodically updated and re-trained based on new training data to keep the model up to date. Examples of suitable statistical models that may be incorporated into the decision model 128 herein may include regression models, such as linear regression models, and stochastic models, such as Markov models, hidden Markov models, and so forth.

In some examples, the delivery service 108 may instruct the delivery associate 106 to the leave the delivery package 110(1) unattended at the customer address 222. For instance, the delivery service 108 may instruct the delivery associate 106(1) to the leave the delivery package 110(1) unattended at the customer address 222(1) when the decision model 128 determines that the risk of loss is below a predetermined threshold and/or the cost of replacing the delivery package 110(1) is below a predefined threshold. Furthermore, the risk of loss determination may take into account the risk of loss associated with the time of day (e.g., morning, mid-day, afternoon, evening, etc.) and/or the individual locations 230 (e.g., front steps, front porch, mailbox, back porch, front desk, doorman, etc.) of the customer address 222(1) available for drop off In some other instances, the delivery service 108 may instruct the delivery associate 106(1) to the leave delivery package 110(1) unattended at the customer addresses 222(1) when the cost of a subsequent delivery attempt is above a predetermined threshold. In some instances, the delivery model 108 may instruct the delivery associate 106(1) to the leave delivery package 110(1) unattended at the customer address 222(1) when the cost of a subsequent delivery attempt is greater than the cost of replacing the delivery package 110(1).

For example, the delivery service 108 may instruct the delivery associate 106(1) to the leave the delivery package 110(1) unattended at the customer address 222(1) when one or more factors (e.g., delivery associate work schedules, delivery service hours of operation, weather, etc.) do not permit the delivery associate 106(1) to be available to attempt redelivery within a specified time period. In some cases, the specified time period may be associated with a timeliness guarantee, business practice, industry standard, and/or customer satisfaction goals. Further, the instruction to leave the delivery package 110 unattended at the customer address 222 may specify one or more locations 230 associated with customer address that are acceptable drop off locations. For example, the decision model 128 may determine that the risk of loss is below a predetermined threshold for leaving the delivery package 110(1) unattended inside a mailbox 230 at the customer address 222. In addition, the delivery service 108 may instruct the delivery associate 106(1) to the leave delivery package 110(1) unattended at the customer address 222(1) based at least in part on the customer profile 242(1) associated with the customer 202(1) indicating that the customer 202(1) is likely to arrive at the customer address 222(1) within a specified period of time. For example, the delivery service 108 may instruct the delivery associate 106(1) to the leave the delivery package 110 unattended at a customer address 222 associated with a business, when the hours of operation of the business indicate that a person authorized to receive the delivery package 110 is likely to arrive at the customer address 222 within a specified period of time.

In some examples, the delivery service 108 may instruct the delivery associate 106(1) to depart the customer address 222(1) with the delivery package 110. Further, the delivery service 108 may instruct the delivery associate 106(1) or one of the other delivery associates 106(2)-106(N) to attempt redelivery of the delivery package 110(1) at a later date and/or time. For instance, the delivery service 108 may instruct the delivery associate 106(1) to attempt redelivery at a later date and/or time when the decision model 128 determines that the risk of the delivery package 110(1) being stolen is above a predetermined threshold and/or the cost of replacing the delivery package 110(1) is above a predetermined threshold. In some other instances, the delivery service 108 may instruct the delivery associate 106(1) to attempt redelivery at later date and/or time when the cost of a subsequent delivery attempt is below a predetermined threshold. For example, the decision model 128 may instruct the delivery associate 106(1) to attempt redelivery at later date and/or time when the cost of a subsequent delivery attempt is less than the cost of replacing the delivery package 110(1). Further, the decision model 128 may instruct the delivery associate 106(1) to obtain a signature confirmation of delivery of the delivery package 110(1) when the decision model 128 determines that the risk of the delivery package 110(1) being stolen is above a predetermined threshold and/or the cost of replacing the delivery package 110(1) is above a predetermined threshold.

In some examples, the delivery service 108 may instruct the delivery associate 106(1) to deliver the delivery package 110 to one of the storage facilities 224. For instance, the delivery service 108 may instruct the delivery associate 106(1) to deliver the delivery package 110 to one of the storage facilities 224 when the decision model 128 determines that the risk of the delivery package 110(1) being stolen is above a predetermined threshold and/or the cost of replacing the delivery package 110(1) is above a predetermined threshold. In some other instances, the delivery service 108 may instruct the delivery associate 106(1) to deliver the delivery package 110(1) to one of the storage facilities 224 when the distance between the particular storage facility 224 and the customer address 222 is below a predetermined threshold.

In some cases, the decision model 128 may determine the cost of redelivery based at least in part on route information 232 associated with the delivery associate 106. For example, the decision model 128 may determine that the delivery associate 106(1) will be available to attempt redelivery later the same day. Further, the decision model 128 may determine a time that the delivery associate 106(1) will attempt redelivery based on customer information 220 associated with the customer 202(1). For instance, the decision model 128 may determine that the customer 202(1) is likely to be at the customer address 222(1) at 4 pm based on the customer profile 242(1). Further, the delivery service 108 may instruct the delivery associate 106(1) to attempt redelivery of the delivery package 110(1) at 4 pm. For instance, the delivery service 108 may send the delivery associate 106(1) route information 232(1) updating the route to include redelivery of the delivery package 110(1) at 4 pm.

In some examples, the delivery service 18 may instruct the delivery associate 106(1) to wait a specified amount of time at the customer address 222(1). For instance, the delivery service 108 may instruct the delivery associate 106(1) to wait a specified amount of time at the customer address 222(1) when the decision model 128 determines that the likelihood that delivery associate 106(1) will have an opportunity to access a location 230 having a low probability of theft within the specified amount of time is above a predetermined threshold. For example, the decision model 128 may determine based at least in part on the customer address profile 218(1) associated with the customer address 222(1) that an occupant of the customer address 222(1), for example, an apartment building or multi-family home, is likely to arrive at the customer address 222(1) within a specified period of time. Once the occupant arrives at the customer address 222(1), the occupant can provide the delivery associate 106(1) access to the location 230 where the delivery associate 106(1) can leave the delivery package 110(1) unattended. In another example, the decision model 128 may determine to wait a specified amount of time at the customer address 222(1) based at least in part on the customer profile 242(1) associated with the customer 202(1) indicating that the customer 202(1) is likely to arrive at the customer address 222(1) within a specified period of time.

Further, the delivery service 108 may provide alternative tasks 126 in the event that an occupant of the customer address 222(1) does not arrive at the customer address 222(1) within a specified period of time. For instance, the delivery service may instruct the delivery associate 106(1) to attempt redelivery of the delivery package 110(1) at a later date and/or time if an occupant of the customer address 222(1) does not arrive at the customer address 222(1) within the specified period of time.

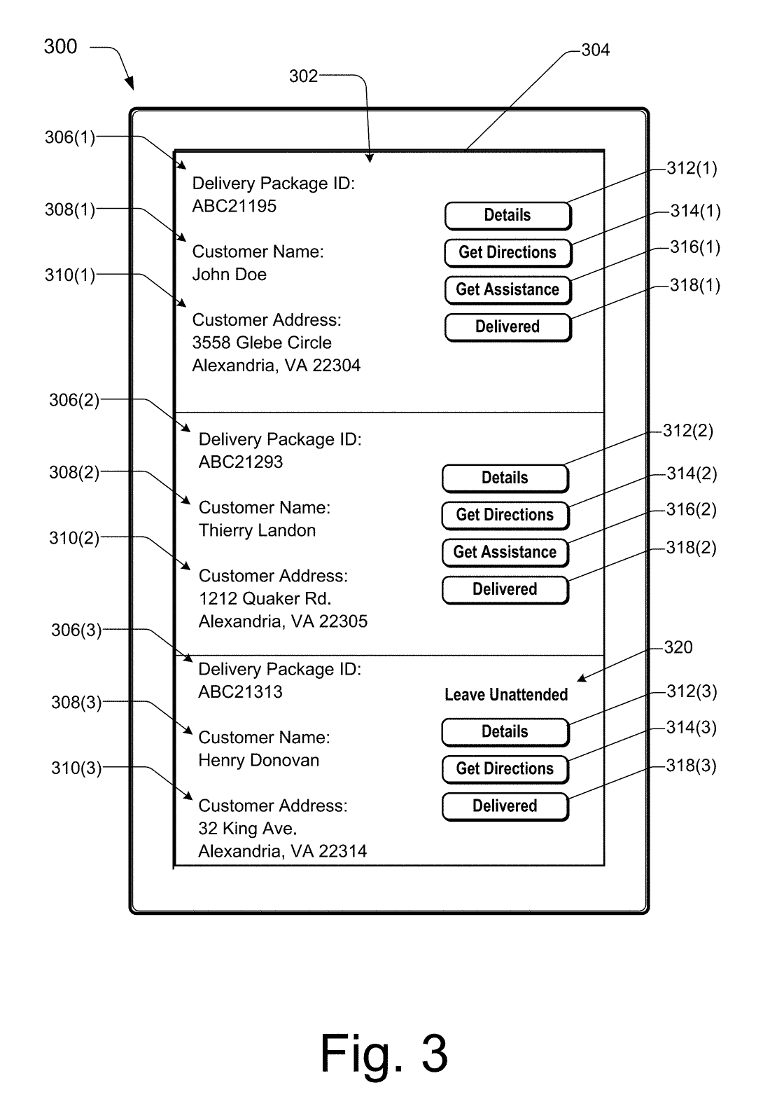

FIG. 3 illustrates an example graphical interface 300 for presenting route information or other information to a delivery associate according to some implementations. For example, route information or other information 302 may be presented on a display 304 associated with a delivery associate device or may be presented to the delivery associate using any other suitable communication technology. As described above, the delivery service may assign delivery orders to delivery associates. Once the delivery orders have been assigned to the delivery associates, the delivery route service may generate route information and provide the route information to the delivery associates.

In the illustrated example, the graphical interface 300 presents the information 302 that applies to the particular delivery associate. In this example, the information 302 includes delivery package identifiers 306, such as 306(1), 306(2), and 306(3), which identify individual delivery packages 110. In addition, the information 302 may include customer identifiers 308, such as 308(1), 308(2), and 308(3), which identify the customers associated with the delivery packages. Further, the information 302 may include customer address identifiers 310, such as 310(1), 310(2), and 310(3), which identify customer addresses associated with the delivery packages. As shown in FIG. 3, the graphical interface 300 may present the information 302 organized by delivery packages 110. For instance, the graphical interface 300 presents the delivery package identifier 306(1), the customer identifier 308(1), and the customer address 310(1) grouped together. In some cases, the information 302 may pop up or otherwise be presented on the display 304 as they are received. Additionally, or alternatively, the information 302 may be viewed by a delivery associate at a later time, such as by accessing a dashboard, selecting a delivery route icon (not shown in FIG. 3), or the like.

In some cases, the delivery associate may select one or more “details” buttons 312, such as 312(1), 312(2), and 312(3), when the delivery associate desires to view to additional information corresponding to delivery packages. Further, the delivery associate may select one or more “get directions” buttons 314, such as 314(1), 314(2), and 314(3), when the delivery associate desires to view directions to the customer addresses corresponding to the customer address identifiers 310. In addition, the delivery associate may select one or more “get assistance” buttons 316, such as 316(1), and 316(2), when the delivery associate desires to send delivery assistance requests to the delivery assistance service. In some examples, the selection of the get assistance button 316 may cause the delivery associate device to send a delivery assistance request to the delivery assistance service.

Further, the delivery associate may select one or more “delivered” buttons 318, such as 318(1), 318(2), and 318(3), when the delivery associate has delivered the delivery packages to the customer addresses corresponding to the customer address identifiers 310. For example, the delivery associate may select the delivered button 318(1), when the delivery associate delivers the delivery package corresponding to the delivery package identifier 306(1) to the customer address corresponding to the customer address identifier 310(1). In some examples, the selection of the delivered button 318 may cause the delivery associate device to send a delivery associate information message to the delivery assistance service.

In the case that the display 304 is a touch screen, the delivery associate may use a finger to select the details buttons 312, the get direction buttons 314, the get assistance buttons 316, or the delivered buttons 318. Alternatively, the user may use a different type of input device such as a mouse, joystick, stylus or any other suitable input device. For instance, the delivery associate may use voice input commands to select the details buttons 312, get direction buttons 314, get assistance buttons 316, or delivered buttons 318.

In some examples, the delivery assistance service 124 may automatically determine one or more tasks associated with a delivery package without receiving a delivery assistance request. Further, the information 302 may include the one or more tasks. For instance, the information 302 may include a task 320 instructing the delivery associate to leave a delivery package unattended at a customer address corresponding to the customer address identifier 310(3).

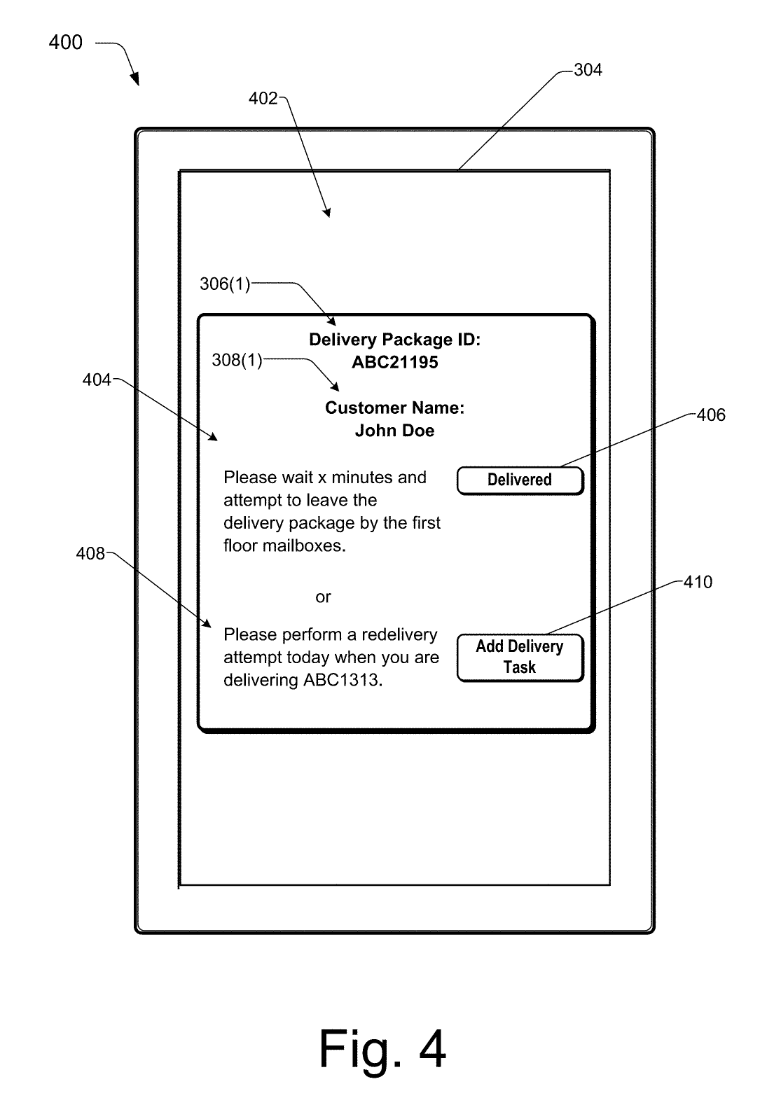

FIG. 4 illustrates an example graphical interface 400 for presenting delivery assistance or other information to a delivery associate according to some implementations. For example, a delivery assistance response or other information 402 may be presented on the display 304 associated with a delivery associate device or may be presented to the delivery associate using any other suitable communication technology. As described above, the delivery assistance service may select the “get assistance” button 316. In response, the information 402 may be displayed overlaid on top of the information 302. In other examples, the information 402 may be displayed as a separate window. In still other examples, the information 402 may be displayed in a side-by-side configuration with the information 302. Further, the information 402 may include the contents of a delivery assistance response corresponding to a delivery package identifier 306. For example, if the delivery associate selected get assistance button 316(1), the information may include the contents of a delivery assistance response associated with the delivery package identifier 306(1).

In the illustrated example, the graphical interface 400 presents the information 402 that applies to the particular delivery assistance response. In this example, the information 402 includes delivery package identifier 306(1) and customer identifier 308(1). In addition, the information 402 may include a primary task 404. For example, the information 402 may instruct the delivery associate to wait eight minutes and attempt to leave the delivery package by mailboxes on a first floor. Further, upon successful completion, the delivery associate may select a primary task button 406 associated with the primary task 404. For example, if the delivery associate gains access to the mailboxes on the first floor and leaves the delivery package unattended, the delivery associate may select a “delivered” button 406.

Further, the information 402 may include one or more secondary tasks 408 as alternatives to the primary task 404. For example, the information 402 may instruct the delivery associate to attempt to deliver the delivery package at a later time if the delivery associate is unable to gain access to the mailboxes on the first floor. Further, the delivery associate may select add secondary task button 410 associated with the secondary task 408. For example, if the delivery associate is unable to gain access to the mailboxes on the first floor, the delivery associate may select an “add delivery task” button 410. The add delivery task button 410 may modify the information 302 to include a redelivery attempt of the delivery package corresponding to the delivery package identifier 306(1). Additionally, or alternatively, the redelivery attempt of the delivery package corresponding to the delivery package identifier 306(1) may be automatically added to the information 302.

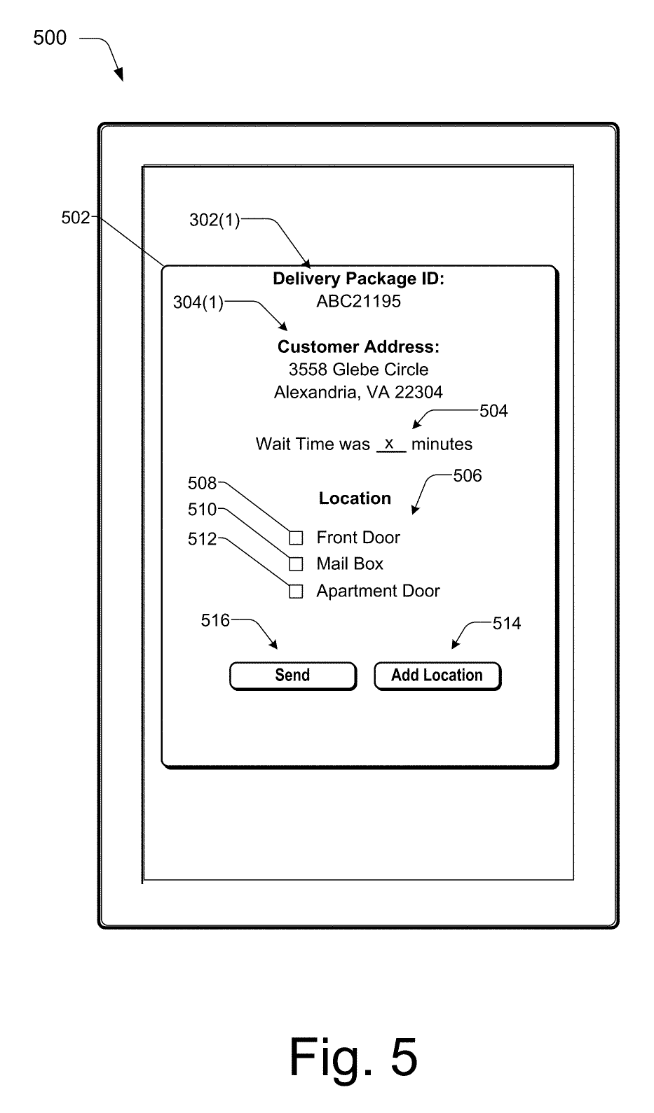

FIG. 5 illustrates an example graphical interface 500 that may be used to enter a wait time and/or a location at a customer address associated with a delivery according to some implementations. As one example, the user may access the interface 500 from the interface 300 or the interface 400, such as by tapping or clicking on the delivered buttons 318 and/or 406. The interface 400 may include a plurality of information 502 corresponding to a delivery package that has been left unattended at a customer address. In the illustrated example, the interface 500 includes the delivery package identifier 302(1), the customer address identifier 304(1), a field 504 for entering an amount of time the delivery associate had to wait at the customer address associated with the customer address identifier 304(1), and a group of checkboxes 506 corresponding to locations at the customer address including a “Front Door” checkbox 508, a “Mailbox” checkbox 510, and an “Apartment Door” checkbox 512. In some examples, the group of checkboxes 506 may be populated based in part on a customer address profile associated with the customer address identifier 304(1). For instance, the customer address profile may correspond to the customer address associated with the customer address identifier 304(1). Further, the customer address profile may include a list of locations available for delivery package drop off at the customer address. By selecting one of the checkboxes 506, the delivery associate may indicate the drop off location of the delivery package associated with the delivery package identifier 302(1).

Further, the delivery associate may select an “Add Location” button 514 to add a checkbox for a new location to the group of checkboxes 506. Additionally, when the delivery associate has finished entering a wait time and/or a location at a customer address, the delivery associate may select a “Send” button or control 516 to send the information 502 to the delivery service. In some examples, the information 502 may be sent to the delivery service as delivery associate information.

In some examples, the delivery associate device 104 and/or the delivery service 108 may automatically determine an amount of time the delivery associate had to wait at the customer address 222. For example, the delivery service 108 may determine a wait time at a customer address 222 based at least in part on a GPS sensor of the delivery associate device 104, traffic information associated with the delivery associate 106, and/or geo-tagging of the delivery associate device 104 via a media access control (“MAC”) address and/or internet protocol (“IP”) address.

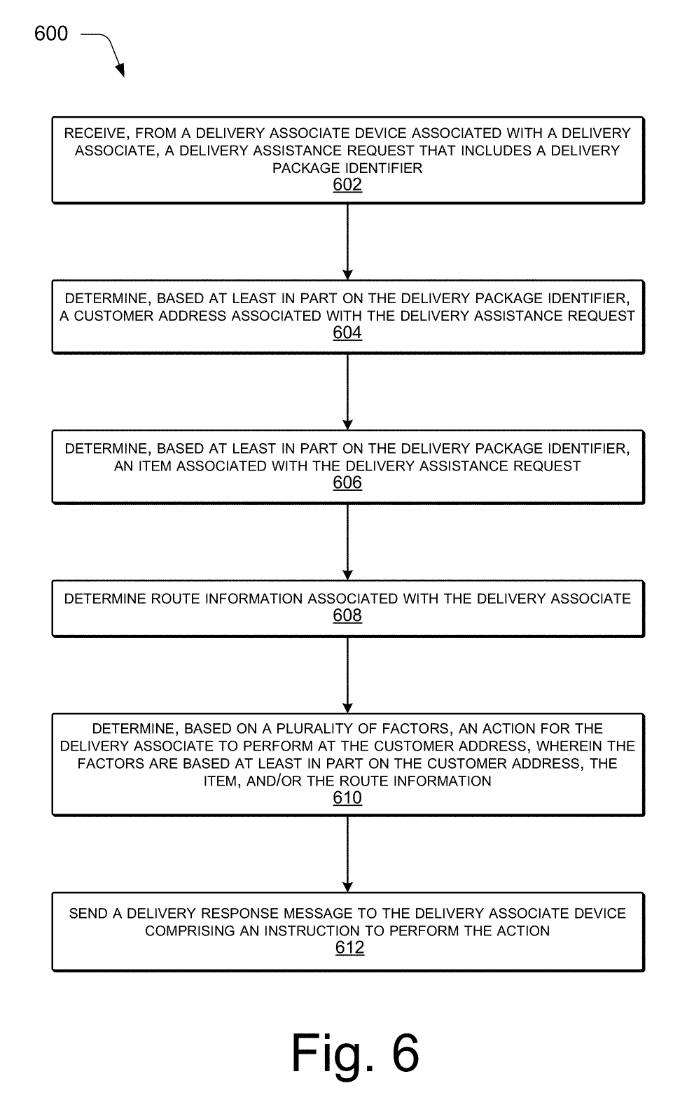

FIG. 6 is an example flow diagram of a process for providing delivery assistance to a delivery associate according to some implementations.

At 602, the one or more service computing devices 108 receive, from a delivery associate device 104 associated with a delivery associate, a delivery assistance request that includes a delivery package identifier. For instance, as discussed above with respect to FIGS. 1-2, the delivery associate 106 may retrieve the delivery package 110 from the storage facility 224. Further, the delivery associate 106 may transport the delivery package 110 to the customer address 222 via the delivery vehicle 234. Upon arrival at the customer address 222, the delivery associate 106 may determine that the customer 202 is unavailable. For instance, the delivery associate 106 may ring a doorbell associated with the customer 222. As a result, the delivery associate 102 may send a delivery assistance request 112 to the delivery service 108 using the delivery associate application 116. In some examples, the delivery assistance request 112 may include a delivery package identifier 118 corresponding to the delivery package 110.

At 604, the one or more computing devices may determine based at least in part on the delivery package identifier, a customer address associated with the delivery assistance request. For example, the delivery service 108 may determine that the customer address 222 is associated with delivery package identifier 118 based at least in part on the delivery order information 210.

At 606, the one or more computing devices may determine, based at least in part on the delivery package identifier, an item associated with the delivery assistance request. For example, the delivery service 108 may determine an item identifier associated with delivery package identifier 118 based at least in part on the delivery order information 210.

At 608, the one or more computing devices may determine route information associated with the delivery associate. For example, the delivery service 108 may determine an a delivery route associated with the delivery associate based at least in part on route information 232 generated by the delivery route service 212.

At 610, the one or more computing devices may determine, based on a plurality of factors, an action for the delivery associate to perform at the customer address, wherein the factors are based at least in part on the customer address, the item, and/or route information.

For example, the delivery service 108, based on output from the decision model 128 of the delivery assistance service 124, may instruct the delivery associate 106 to the leave the delivery package 110 unattended at the customer address 222. For instance, the delivery service 108 may instruct the delivery associate 106 to leave the delivery package 110 unattended at the customer address 222 based at least in part on theft information associated with the customer address 222 and/or the locale 228 including the customer address 222. In some other instances, the delivery service 108 may instruct the delivery associate 106 to leave the delivery package 110 unattended at the customer address 222 based at least in part on route information 232 indicating that the delivery associate 106 will not have an opportunity to attempt to redeliver the delivery package 110 within a predetermined period of time.

As another example, the delivery service 108, based on output from the decision model 128 of the delivery assistance service 124, may instruct the delivery associate to redeliver the delivery package 110 at a later date and/or time. For instance, the delivery service 108 may instruct the delivery associate 106 to redeliver the delivery package 110 at a later date and/or time based at least in part on route information 232 associated with the delivery associate 106 indicating that the cost of falling behind a delivery schedule is greater than a predetermined threshold. In some instances, the delivery service 108 may instruct the delivery associate 106 to redeliver the delivery package 110 at a later date and/or time based at least in part on the item database 208 indicating that the delivery package 110 has a high monetary value.

Alternatively, or additionally, the delivery assistance service 124 may automatically determine an action for the delivery associate 106 to perform with respect to a delivery package 110 without receiving a delivery assistance request 112. For example, the delivery service 108 may send the delivery associate 106(1) route information 232(1) that includes an action for the delivery associate 106(1) to perform at the customer address 222(1).

At 612, the one or more computing devices send a delivery assistance response message to the delivery associate device comprising an instruction to perform the action. For instance, as discussed above with respect to FIG. 1, the delivery service 108 may send the delivery assistance response 130 to the delivery associate device 104. Further, the delivery associate application 116 may present the instructions to the delivery associate 106 as illustrated in FIG. 4.

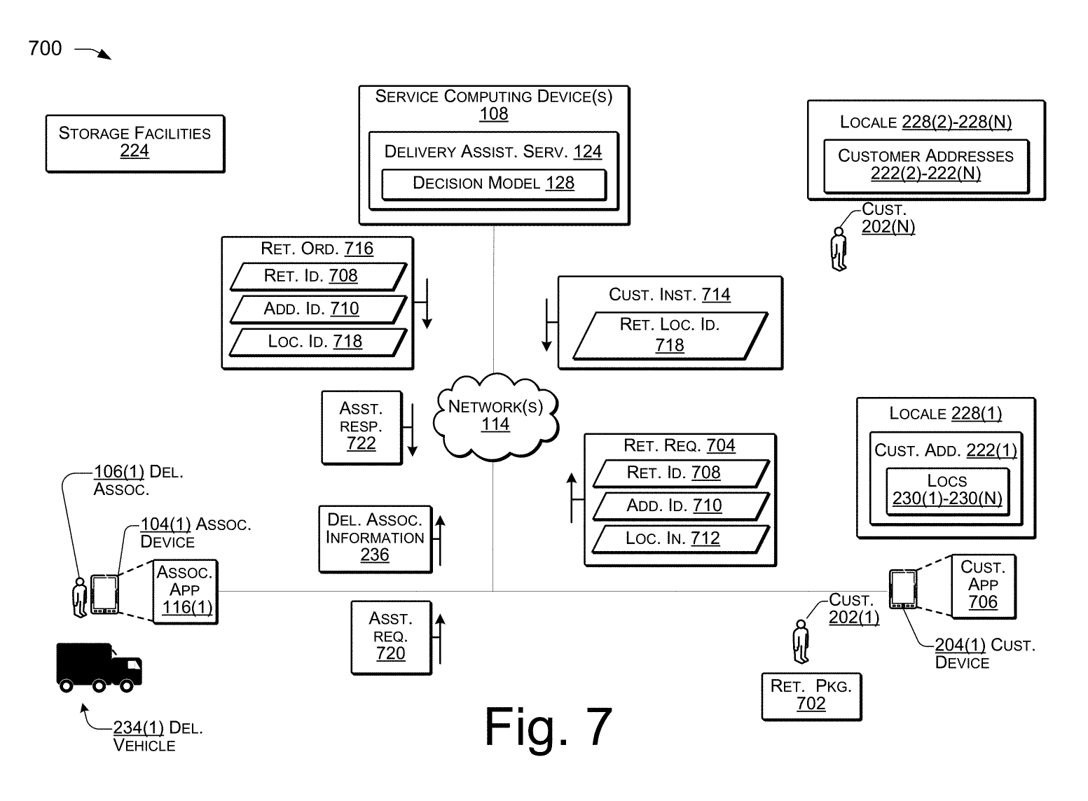

FIG. 7 illustrates an example environment 700 for a delivery service according to some implementations. FIG. 7 shows illustrative interactions between delivery associate devices 104, the delivery service 108, and customer devices 204, when performing various operations, including providing return package assistance to customers 202 via the delivery assistance service 124.

In the illustrative example of FIG. 7, suppose the customer 202(1) is unsatisfied with an item in the delivery package 110 (not shown in FIG. 7) received from the delivery service 108, and would like to return the item in a return package 702 to the delivery service 108. The customer 202(1) may send a return assistance request 704 to the delivery service 108 via the network 114. In some examples, the customer 202(1) may use a customer application 706 installed on the customer device 204(1) to send the return assistance request 704. Additionally, or alternatively, the customer device 204(1) may access a website (e.g., a delivery service website) that offers functionality similar to the customer application 706 via a web browser application.

In some examples, the return assistance request 704 may include a return package identifier 708 that identifies the return package 702. In some examples, the delivery service 108 may generate the return package identifier and assign the return package identifier 708 to the return package 702. Typically, but not necessarily, the return package 702 is tagged or otherwise marked with the return package identifier 708. For example, package 702 may be marked or tagged with a bar code, 2D/3D bar code, Quick Response (QR) code, Near Field Communication (NFC) tag, Radio Frequency Identifier Device (RFID) tag, magnetic stripe, Universal Product Code (UPC), Stock-Keeping Unit (SKU) code, serial number, and/or other designation (including proprietary designations) that may be used as identifiers to facilitate fulfillment system operations. In some examples, the return package identifier 708 may include the delivery package identifier 118 (not shown in FIG. 7).

Further, the return assistance request 704 may include a customer address identifier 710 that identifies the customer address 222(1). In some examples, the return assistance request 704 may further include location information 712 that identifies one or more locations 230 available as pick up locations for the return package 702 at the customer address 222(1). For example, the location information 712 may indicate that the customer 202(1) may leave the return package 702 with a doorman at the customer address 222(1). In some other examples, the location information 712 indicates that the customer 202(1) may leave the return package 702 with a neighbor at or near the customer address 222(1). The location information 712 may further include availability information associated with the one or more locations 230. For instance, the location information 712 may indicate that the customer 202(1) will be available on the weekend at the customer address 222(1) to present the return package 702 to one of the delivery associates 106. In some other instances, the location information 712 may indicate the hours during which a doorman is available to present the return package 702 to one of the delivery associates 106.

The delivery service 108 may receive the return assistance request 704 and provide the return assistance request 704 to the delivery assistance service 124. Further, the delivery assistance service 124 may determine customer instructions 714 for the customer 202(1) to perform based on the decision model 128. In some cases, the decision model 128 may determine whether the customer 202(1) can leave the return package 702 at one of the locations 230 of the customer address 222(1), present the return package 702 to one of the delivery associates 106, or transport the return package 702 to one of the storage facilities 224. In addition, the delivery service 108 may send the customer instructions 714 to the customer device 204(1). Further, the delivery service 108 may send a return order 716 corresponding to the customer instructions 714 to one of the delivery associates 106. For example, if the customer instructions 714 include presenting the return package 702 to the particular delivery associate 106(1), the delivery service 108 may send, to the delivery associate device 104(1), the return order 716 instructing the delivery associate 106(1) to pick up the return package 702 from the customer address 222(1). In addition, the return order 716 may instruct the delivery associate 106(1) to deliver the return package 702 to one of the storage facilities 224 or another customer 202(N).

The customer instructions 714 may include a return package location identifier 718 that identifies where the customer 202(1) should leave the return package 702 for one of the delivery associates 106. For instance, the customer instructions 714 may include an instruction for the customer 202(1) to leave the return package 702 with the doorman at the customer address 222(1). In some other examples, the customer instructions 714 may include a date and/or time when one of the delivery associates 106 will pick up the return package 702. For instance, the customer instructions 714 may include an instruction for the customer 202(1) to present the return package 702 to one of the delivery associates 106 during a specified period of time.

The decision model 128 may determine the customer instructions 714 based at least in part on the customer address identifier 710, the return package identifier 708, and the location information 712. As described in detail herein, the decision model 128 may account for numerous pieces of information including the customer address 222, risks associated with locations 230 within the customer address 222, locale information 216, monetary values associated with the return package 702, replacement attributes associated with the return package 702, theft and loss statistics, crime statistics, route information 232 associated with one or more delivery associates 106 operating in proximity to the customer address 222, wait times associated with previous delivery attempts and/or return attempts at the customer address 222, a type or category of the customer 202, customer address profiles 218, customer information 220, time of day, day of the week, seasonality, weather, etc.

For instance, the delivery assistance service 124 may instruct the customer 202(1) to leave the return package 702 at a particular location 230 of the customer address 222(1) based upon the probability of theft or loss of the return package 702 if left unattended at the customer address 222. Further, the decision model 128 may determine the particular location 230 based upon comparing the probability of theft or loss of the return package 702 associated with each location 230 provided by the customer 202(1) in the location information 712. In some other instances, the delivery assistance service 124 may instruct the customer 202(1) to leave the return package 702 at a particular location 230 of the customer address 222(1) based upon the cost of one of the delivery associates 106 arriving at a date and time when the customer 202(1) is available at the customer address 222. For example, the decision model 128 may determine that the cost of the delivery associate 106(1) picking up the return package 702 at a date and time when a doorman is available at the customer address 222(1) is lower than the cost of the delivery associate 106(1) picking up the return package 702 at a date and time when the customer is available at the customer address 222. Thus, the customer instructions 714 may include an instruction to leave the return package 702 with the doorman.

Further, the delivery assistance service 124 may select the particular delivery associate 106 to pick up the return package 702. For instance, the decision model 128 may determine that the cost of the particular delivery associate 106(1) picking up the return package 702 is below a specified threshold based upon the customer address 222(1) and route information 232(1) associated with the delivery associate 106(1). As such, the customer instructions 714 may include an instruction to present the return package 702 to the delivery associate 106(1). Alternatively, the customer instructions 714 may include an instruction to leave the return package 702 at a location within the customer address 222 for the delivery associate 106(1). In some examples, the decision model 128 may select the particular delivery associate 106(1) based at least in part upon minimizing the amount of time the return package 702 is left unattended at the customer address 222. Further, the delivery route service 212 (not shown in FIG. 7) may provide an estimated time of arrival at the customer address 222 for the delivery associate 106(1).

As illustrated in FIG. 7, the return order 716 may include the return package identifier 708, the customer address identifier 710, and/or the return package location identifier 718. In some instances, the return order 716 may further include information similar to the route information 232(1). For example, the return order 716 may include the customer identifier 308(1).

In addition, if the delivery associate 106(1) is unable to access the location of the customer address 222 corresponding to the return package location identifier 718, the delivery associate 106(1) may use the delivery associate device 104(1) to send a return assistance request 720 to the delivery service 108. In response, the delivery service 108 may send a return assistance response 722 to the delivery associate 106(1) that instructs the delivery associate 106(1) to wait a specified period of time to gain access to the location corresponding to the return package location identifier 718 and/or attempt to retrieve the return package 702 at a later date and/or time. As further described herein with respect to delivery packages 110, the decision model 128 may determine the amount of time to wait until access is gained to the location of the customer address 222 corresponding to the return package location identifier 718.

Once the delivery associate retrieves the return package 702, the delivery associate 106(1) may send delivery associate information 236 to the delivery service 108 using the delivery associate application 116(1). The delivery associate information 236 may include an amount of time the delivery associate 106(1) spent waiting to gain access to the location of the customer address 222 corresponding to the return package location identifier 718. Further, the delivery associate information 236 may include return confirmation information. The return confirmation information may include the return package identifier 708 and/or the date and time of the pickup.

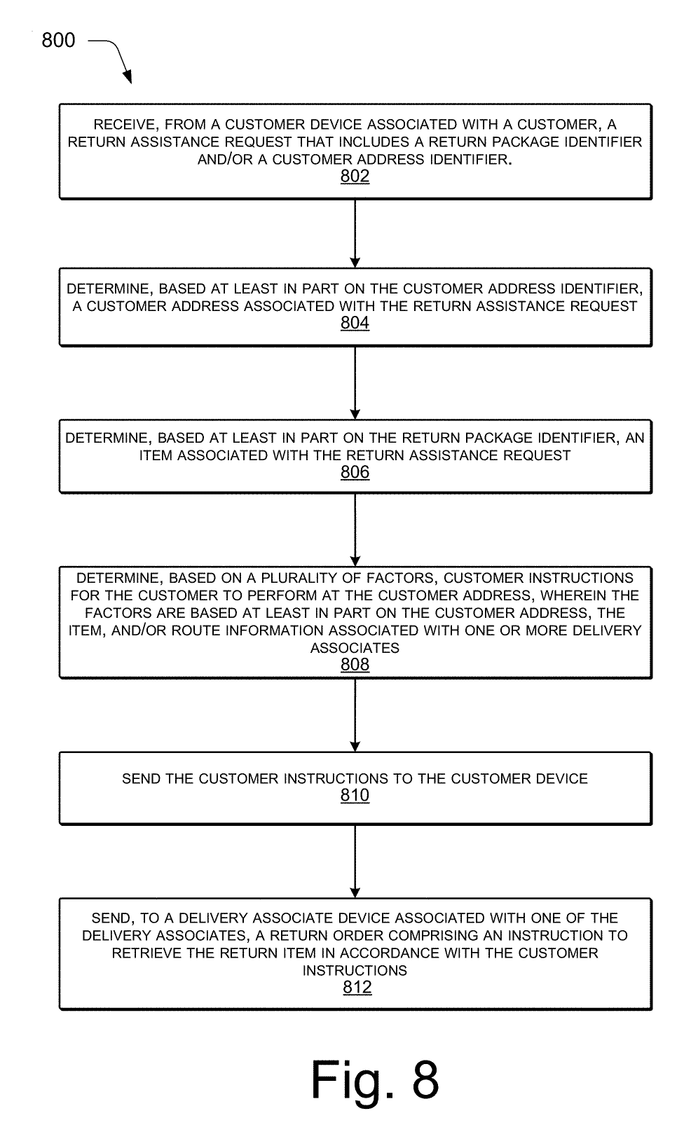

FIG. 8 is an example flow diagram of a process for providing return assistance to a customer according to some implementations.

At 802, the one or more service computing devices 108 receive, from a customer device associated with a customer, a return assistance request that includes a return package identifier. For instance, as discussed above with respect to FIG. 7, the customer 202 may wish to return the return package 702 to the delivery service 108. As a result, the customer 202 may send a return assistance request 704 to the delivery service 108 using the customer application 706. In some examples, the return assistance request 704 may include the return package identifier 708 corresponding to the return package 702, and the customer address identifier 710 corresponding to the customer address 222.

At 804, the one or more computing devices determine, based at least in part on customer address identifier, a customer address associated with the return assistance request. For example, the delivery service 108 may determine that the customer address 222 is associated with the return assistance request 704 based at least in part on the customer address identifier 710.

At 806, the one or more computing devices may determine, based at least in part on the return package identifier, an item associated with the return assistance request. For example, the delivery service 108 may determine an item associated with return assistance request 704 based at least in part on the return package identifier 708. In some instances, the return package identifier 708 may be associated with delivery order information 210 corresponding to the delivery of the one or more items of the return package 702.

At 808, the one or more computing devices may determine, based on a plurality of factors, customer instructions for the customer to perform at the customer address, wherein the factors are based at least in part on the customer address, the item, and/or route information associated with one or more delivery associates.

For example, the delivery service 108, based on output from the decision model 128 of the delivery assistance service 124, may instruct the customer to the leave the return package 702 unattended at the customer address 222 for the delivery associate 106(1) to retrieve. For instance, the delivery service 108 may instruct the customer 202 to leave the return package 702 unattended at the customer address 222 based at least in part on theft information associated with the customer address 222 and/or the locale 228 including the customer address 222. In some other instances, the delivery service 108 may instruct the customer 202 to leave the return package 702 unattended at the customer address 222 based at least in part on route information 232 indicating that the delivery associate 106(1) will have an opportunity to retrieve the return package 702 within a predetermined period of time.

As another example, the delivery service 108, based on output from the decision model 128 of the delivery assistance service 124, may instruct the customer 202 to present the return package 702 to the particular delivery associate 106(1) during a specified period of time. For instance, the delivery service 108 may instruct customer 202 to present the return package 702 to a particular delivery associate 106(1) during a specified period of time based at least in part on route information 232(1) associated with the delivery associate 106(1) indicating that the cost of the delivery associate 106(1) traveling to the customer address 222(1) during the specified period of time is lower than a predetermined threshold. In some instances, the delivery service 108 may instruct the customer 202 to present the return package 702 to the delivery associate 106(1) during a specified period of time based at least in part on the item database 208 indicating that the return package 702 has a high monetary value.

At 810, the one or more computing devices send the customer instructions to the customer device. For instance, as discussed above with respect to FIG. 7, the delivery service 108 may send the customer instructions 714 to the customer device 204(1). Further, the customer application 706 may present the customer instructions 714 to the customer 202.

At 812, the one or more computing devices send, to a delivery associate device associated with one of the delivery associates, a return order comprising an instruction to retrieve the return item in accordance with the customer instructions. For instance, as discussed above with respect to FIG. 7, the delivery service 108 may send the return order 716 to the delivery associate device 104(1). Further, the delivery associate application 116 may present the return order 716 to the delivery associate 106.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

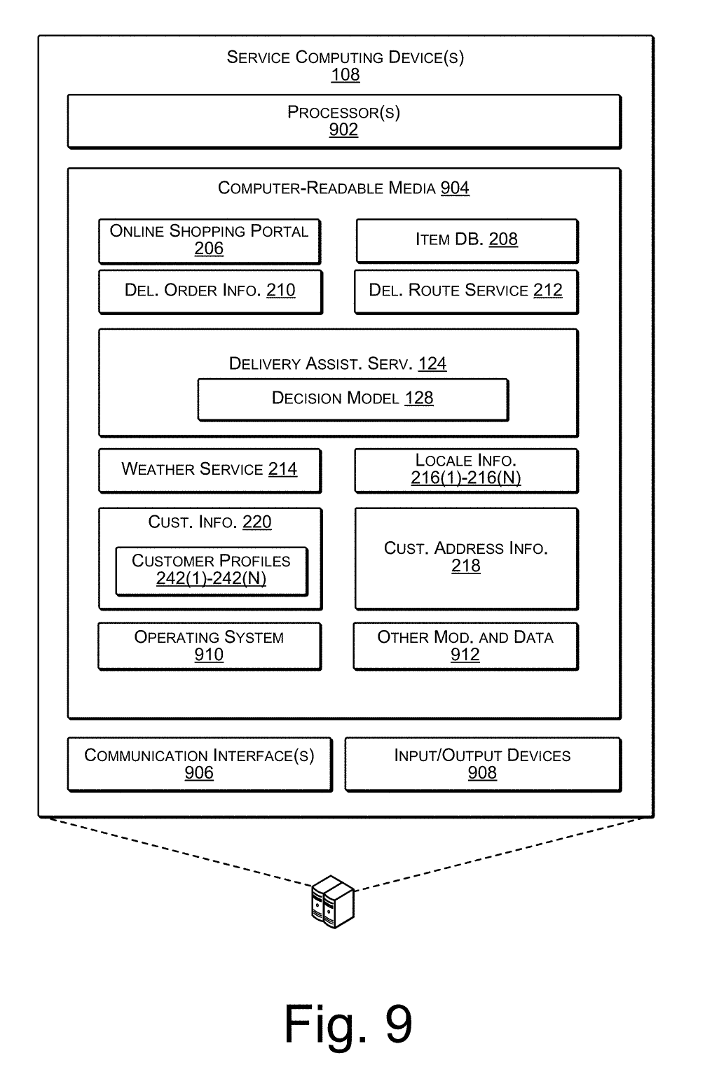

FIG. 9 illustrates select components of the delivery service computing device 108 that may be used to implement some functionality of the delivery assistance service 124 described herein. The delivery service computing device 108 may include one or more servers or other types of computing devices that may be embodied in any number of ways. For instance, in the case of a server, the modules, other functional components, and data may be implemented on a single server, a cluster of servers, a server farm or data center, a cloud-hosted computing service, a cloud-hosted storage service, and so forth, although other computer architectures may additionally or alternatively be used.

Further, while the figures illustrate the components and data of the delivery service computing devices 108 as being present in a single location, these components and data may alternatively be distributed across different computing devices and different locations in any manner. Consequently, the functions may be implemented by one or more service computing devices, with the various functionality described above distributed in various ways across the different computing devices. Multiple delivery service computing devices 108 may be located together or separately, and organized, for example, as virtual servers, server banks and/or server farms. The described functionality may be provided by the servers of a single entity or enterprise, or may be provided by the servers and/or services of multiple different entities or enterprises.

In the illustrated example, each delivery service computing device 108 may include one or more processors 902, one or more computer-readable media 904, and one or more communication interfaces 906. Each processor 902 may be a single processing unit or a number of processing units, and may include single or multiple computing units or multiple processing cores. The processor(s) 902 can be implemented as one or more microprocessors, microcomputers, microcontrollers, digital signal processors, central processing units, state machines, logic circuitries, and/or any devices that manipulate signals based on operational instructions. For instance, the processor(s) 902 may be one or more hardware processors and/or logic circuits of any suitable type specifically programmed or configured to execute the algorithms and processes described herein. The processor(s) 902 can be configured to fetch and execute computer-readable instructions stored in the computer-readable media 904, which can program the processor(s) 902 to perform the functions described herein.

The computer-readable media 904 may include volatile and nonvolatile memory and/or removable and non-removable media implemented in any type of technology for storage of information, such as computer-readable instructions, data structures, program modules, or other data. Such computer-readable media 904 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the delivery service computing device 108, the computer-readable media 904 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 904 may be used to store any number of functional components that are executable by the processors 902. In many implementations, these functional components comprise instructions or programs that are executable by the processors 902 and that, when executed, specifically configure the one or more processors 902 to perform the actions attributed above to the delivery service computing device 108. In addition, the computer-readable media 904 may store data used for performing the operations described herein.

In the illustrated example, the functional components stored in the computer-readable media 904 may include the online shopping portal 206, the delivery route service 212, and the delivery assistance service 124, including the decision model 128. Further, the computer-readable media 904 may store the item database 208, the delivery order information 210, information from the weather service 214, the locale information 216, customer address information 218 and customer information 220, including the customer profiles 242.

Additional functional components stored in the computer-readable media 904 may include an operating system 910 for controlling and managing various functions of the delivery service computing device 108. The delivery service computing device 108 may also include or maintain other functional components and data, such as other modules and data 912, which may include programs, drivers, etc., and the data used or generated by the functional components. Further, the delivery service computing device 108 may include many other logical, programmatic and physical components, of which those described above are merely examples that are related to the discussion herein.

The communication interface(s) 906 may include one or more interfaces and hardware components for enabling communication with various other devices, such as the customer device(s) 204, delivery associate device(s) 104 or other computing devices, over the network(s) 114. For example, communication interface(s) 906 may facilitate communication through one or more of the Internet, cable networks, cellular networks, wireless networks (e.g., Wi-Fi, cellular) and wired networks. As several examples, the delivery service computing device 108 and the customer device 204 may communicate and interact with one another using any combination of suitable communication and networking protocols, such as Internet protocol (IP), transmission control protocol (TCP), hypertext transfer protocol (HTTP), cellular or radio communication protocols, and so forth.

The delivery service computing device 108 may further be equipped with various input/output (I/O) devices 908. Such I/O devices 908 may include a display, various user interface controls (e.g., buttons, joystick, keyboard, mouse, touch screen, etc.), audio speakers, connection ports and so forth.

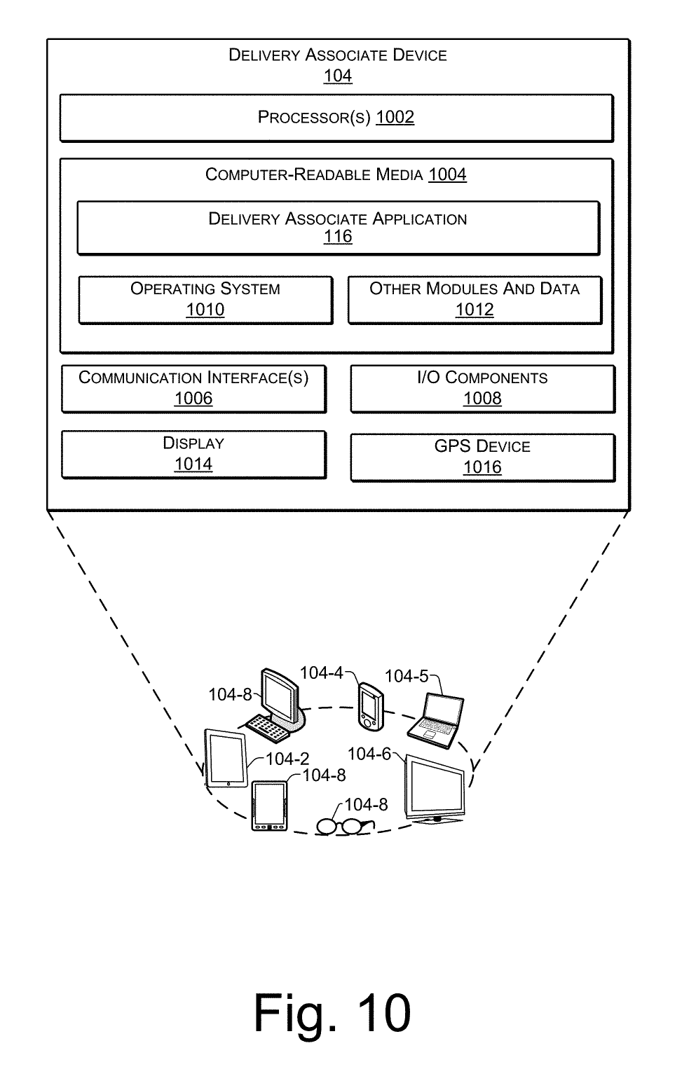

FIG. 10 illustrates select example components of the delivery associate device 104 that may implement the functionality described above according to some examples. The delivery associate device 104 may be any of a number of different types of personal computing devices. Some examples of the delivery associate device 104 may include desktops, laptops, netbooks and other portable computers, smart phones and mobile communication devices; tablet computing devices; embedded computing devices; wearable computing devices and/or body-mounted computing devices, which may include watches and augmented reality devices, such as helmets, goggles or glasses; and any other portable device capable of sending communications and performing the functions according to the techniques described herein.

In the example of FIG. 10, the delivery associate device 104 includes components such as at least one processor 1002, one or more computer-readable media 1004, one or more communication interfaces 1006, and one or more input/output (I/O) devices 1008. Each processor 1002 may itself comprise one or more processors or processing cores. For example, the processor 1002 can be implemented as one or more microprocessors, microcomputers, microcontrollers, digital signal processors, central processing units, state machines, logic circuitries, and/or any devices that manipulate signals based on operational instructions. In some cases, the processor 1002 may be one or more hardware processors and/or logic circuits of any suitable type specifically programmed or configured to execute the algorithms and processes described herein. The processor 1002 can be configured to fetch and execute computer-readable processor-executable instructions stored in the computer-readable media 1004.

Depending on the configuration of the delivery associate device 104, the computer-readable media 1004 may be an example of tangible non-transitory computer storage media and may include volatile and nonvolatile memory and/or removable and non-removable media implemented in any type of technology for storage of information such as computer-readable processor-executable instructions, data structures, program modules or other data. The computer-readable media 1004 may include, but is not limited to, RAM, ROM, EEPROM, flash memory, solid-state storage, magnetic disk storage, optical storage, and/or other computer-readable media technology. Further, in some cases, the delivery associate device 104 may access external storage, such as RAID storage systems, storage arrays, network attached storage, storage area networks, cloud storage, or any other medium that can be used to store information and that can be accessed by the processor 1002 directly or through another computing device or network. Accordingly, the computer-readable media 1004 may be computer storage media able to store instructions, modules or components that may be executed by the processor 1002. Further, when mentioned, non-transitory computer-readable media exclude media such as energy, carrier signals, electromagnetic waves, and signals per se.

The computer-readable media 1004 may be used to store and maintain any number of functional components that are executable by the processor 1002. In some implementations, these functional components comprise instructions or programs that are executable by the processor 1002 and that, when executed, implement operational logic for performing the actions and services attributed above to the delivery associate device 104. Functional components of the delivery associate device 104 stored in the computer-readable media 1004 may include the delivery associate application 116. Additional functional components may include an operating system 1010 for controlling and managing various functions of the delivery associate device 104 and for enabling basic user interactions with the delivery associate device 104.

In addition, the computer-readable media 1004 may also store data, data structures and the like, that are used by the functional components. Depending on the type of the delivery associate device 104, the computer-readable media 1004 may also optionally include other functional components and data, such as other modules and data 1012, which may include applications, programs, drivers, etc., and the data used or generated by the functional components. Further, the delivery associate device 104 may include many other logical, programmatic and physical components, of which those described are merely examples that are related to the discussion herein.

The communication interface(s) 1006 may include one or more interfaces and hardware components for enabling communication with various other devices, such as over the network(s) 114 or directly. For example, communication interface(s) 1006 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

FIG. 10 further illustrates that the delivery associate device 104 may include a display 1014. Depending on the type of computing device used as the delivery associate device 104, the display may employ any suitable display technology. For example, the display 1014 may be a liquid crystal display, a plasma display, a light emitting diode display, an OLED (organic light-emitting diode) display, an electronic paper display, or any other suitable type of display able to present digital content thereon. In some examples, the display 1014 may have a touch sensor associated with the display 1014 to provide a touchscreen display configured to receive touch inputs for enabling interaction with a graphic interface presented on the display 1014. Accordingly, implementations herein are not limited to any particular display technology. Alternatively, in some examples, the delivery associate device 104 may not include a display.

The delivery associate device 104 may further include the one or more I/O devices 1008. The I/O devices 1008 may include speakers, a microphone, a camera, and various user controls (e.g., buttons, a joystick, a keyboard, a keypad, etc.), a haptic output device, and so forth.

Other components included in the delivery associate device 104 may include various types of sensors, which may include a GPS device 1016 (or other location determining device) able to indicate location information, as well as other sensors (not shown) such as an accelerometer, gyroscope, compass, proximity sensor, and the like. Additionally, the delivery associate device 104 may include various other components that are not shown, examples of which include removable storage, a power source, such as a battery and power control unit, and so forth.

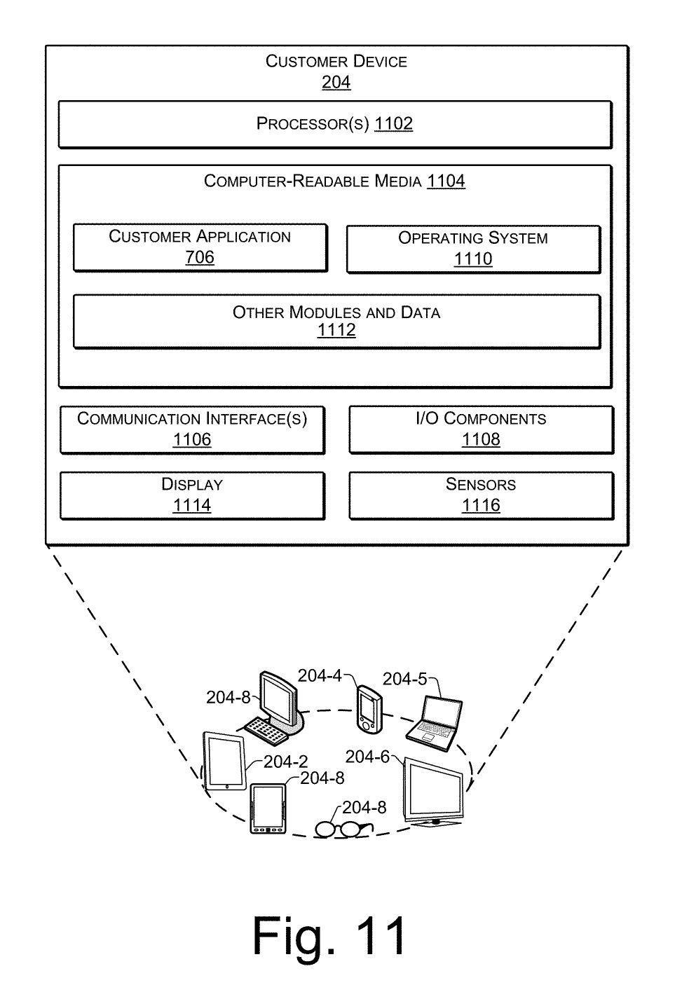

FIG. 11 illustrates select example components of the customer device 204 that may implement the functionality described above according to some examples. The customer device 204 may be any of a number of different types of personal computing devices. Some examples of the customer device 204 may include desktops, laptops, netbooks and other portable computers, smart phones and mobile communication devices; tablet computing devices; wearable computing devices and/or body-mounted computing devices, which may include watches and augmented reality devices, such as helmets, goggles or glasses; and any other portable device capable of sending communications and performing the functions according to the techniques described herein.

In the example of FIG. 11, the customer device 204 includes components such as at least one processor 1102, one or more computer-readable media 1104, one or more communication interfaces 1106, and one or more input/output (I/O) devices 1108. Each processor 1102 may itself comprise one or more processors or processing cores. For example, the processor 1102 can be implemented as one or more microprocessors, microcomputers, microcontrollers, digital signal processors, central processing units, state machines, logic circuitries, and/or any devices that manipulate signals based on operational instructions. In some cases, the processor 1102 may be one or more hardware processors and/or logic circuits of any suitable type specifically programmed or configured to execute the algorithms and processes described herein. The processor 1102 can be configured to fetch and execute computer-readable processor-executable instructions stored in the computer-readable media 1104.

Depending on the configuration of the customer device 204, the computer-readable media 1104 may be an example of tangible non-transitory computer storage media and may include volatile and nonvolatile memory and/or removable and non-removable media implemented in any type of technology for storage of information such as computer-readable processor-executable instructions, data structures, program modules or other data. The computer-readable media 1104 may include, but is not limited to, RAM, ROM, EEPROM, flash memory, solid-state storage, magnetic disk storage, optical storage, and/or other computer-readable media technology. Further, in some cases, the customer device 204 may access external storage, such as RAID storage systems, storage arrays, network attached storage, storage area networks, cloud storage, or any other medium that can be used to store information and that can be accessed by the processor 1102 directly or through another computing device or network. Accordingly, the computer-readable media 1104 may be computer storage media able to store instructions, modules or components that may be executed by the processor 1102. Further, when mentioned, non-transitory computer-readable media exclude media such as energy, carrier signals, electromagnetic waves, and signals per se.

The computer-readable media 1104 may be used to store and maintain any number of functional components that are executable by the processor 1102. In some implementations, these functional components comprise instructions or programs that are executable by the processor 1102 and that, when executed, implement operational logic for performing the actions and services attributed above to the customer device 204. Functional components of the customer device 204 stored in the computer-readable media 1104 may include a customer application 706. In this example, the customer application 706 may present the customer 202 with an interface for sending customer information, such as delivery feedback 238, device activity 240, and return assistance request 704. Further, the customer application 706 may present the customer 202 with an interface for receiving the customer instructions 714. Additional functional components may include an operating system 1110 for controlling and managing various functions of the customer device 204 and for enabling basic user interactions with the customer device 204.

In addition, the computer-readable media 1104 may also store data, data structures and the like, that are used by the functional components. Depending on the type of the customer device 204, the computer-readable media 1104 may also optionally include other functional components and data, such as other modules and data 1112, which may include applications, programs, drivers, etc., and the data used or generated by the functional components. Further, the customer device 204 may include many other logical, programmatic and physical components, of which those described are merely examples that are related to the discussion herein.

The communication interface(s) 1106 may include one or more interfaces and hardware components for enabling communication with various other devices, such as over the network(s) 114 or directly. For example, communication interface(s) 1106 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

FIG. 11 further illustrates that the customer device 204 may include a display 1114. Depending on the type of computing device used as the customer device 204, the display may employ any suitable display technology. For example, the display 1114 may be a liquid crystal display, a plasma display, a light emitting diode display, an OLED (organic light-emitting diode) display, an electronic paper display, or any other suitable type of display able to present digital content thereon. In some examples, the display 1114 may have a touch sensor associated with the display 1114 to provide a touchscreen display configured to receive touch inputs for enabling interaction with a graphic interface presented on the display 1114. Accordingly, implementations herein are not limited to any particular display technology. Alternatively, in some examples, the customer device 204 may not include a display.

The customer device 204 may further include the one or more I/O devices 1108. The I/O devices 1108 may include speakers, a microphone, a camera, and various user controls (e.g., buttons, a joystick, a keyboard, a keypad, etc.), a haptic output device, and so forth

Other components included in the customer device 204 may include various types of sensors 1116, which may include a GPS device (or other location determining device) able to indicate location information, an accelerometer, gyroscope, compass, proximity sensor, and the like. Additionally, the customer device 204 may include various other components that are not shown, examples of which include removable storage, a power source, such as a battery and power control unit, and so forth.

Although the subject matter has been described in language specific to structural features, it is to be understood that the subject matter defined in the appended claims is not necessarily limited to the specific features described. Rather, the specific features are disclosed as illustrative forms of implementing the claims.

1. A system comprising:
a locale database configured to store locale theft information for a geographic region associated with a customer address, wherein the locale theft information comprises incidents of theft within the geographic region;
an item database comprising item information identifying a replacement cost of an item within a delivery system;
a customer address profile database configured to store wait time information and customer address theft information for the customer address, wherein the wait time information includes a history of time spent waiting for access to the customer address during previous delivery attempts and the customer address theft information includes incidents of theft associated with the customer address;
one or more processors; and
one or more computer-readable media storing instructions executable by the one or more processors, wherein the instructions program the one or more processors to implement a service to:
assign a delivery order to a delivery associate, wherein the delivery order is associated with an item identifier that identifies the item, a customer identifier that identifies a customer receiving the item, a customer address identifier that identifies a delivery destination of the item, and a delivery package identifier that identifies a delivery package containing the item;
receive, from a delivery associate device associated with the delivery associate, a delivery assistance request comprising the delivery package identifier;
determine, based at least in part on route information, a cost of a redelivery attempt by the delivery associate, wherein the route information comprises a day of delivery and a plurality of additional delivery orders assigned to the delivery associate;
determine, based at least in part on the locale database and customer address profile database, a probability of theft of the delivery package if left unattended at the customer address;
determine an expected wait time based at least in part on the customer address profile, wherein the expected wait time estimates a length of time until the delivery associate gains access to the customer address;
determine, based at least in part on the route information, a cost of waiting at the customer address for the expected wait time;
generate one or more tasks for the delivery associate to perform at the customer address based at least in part on the cost of the redelivery attempt on the day of delivery, the probability of theft, the cost of waiting at the customer address, and the replacement cost of the item, wherein the one or more tasks comprise performing the redelivery attempt at the customer address at a later time on the day of delivery; and
send a delivery assistance response to the delivery associate device, wherein the delivery assistance response includes the one or more tasks at the later time.

2. The system as recited in claim 1, wherein the one or more tasks further include at least one of:
leaving the delivery package unattended at the customer address;
waiting the expected wait time for an occupant of the customer address to arrive;
obtaining signature confirmation of a delivery of the delivery package; or
delivering the delivery package to a storage facility.

3. The system as recited in claim 1, wherein the one or more tasks include leaving the delivery package unattended at the customer address, and the instructions further program the one or more processors to:
receive a delivery feedback message from a customer device associated with the customer address, wherein the delivery feedback message includes information indicating whether the delivery package was received by the customer; and
update the customer address theft information based at least in part on the delivery feedback message.

4. The system as recited in claim 1, wherein the instructions further program the one or more processors to update the route information to include the redelivery attempt of the delivery package at the later time.

5. A method comprising:
receiving, by a computing device from a delivery associate device associated with a delivery associate, a delivery assistance request that includes a delivery package identifier;
determining, by the computing device, based at least in part on the delivery package identifier, a customer address associated with the delivery assistance request;
determining, by the computing device, based at least in part on the delivery package identifier, an item associated with the delivery assistance request;
receiving, from a locale database, locale theft information for a geographic region associated with the customer address, wherein the locale theft information comprises incidents of theft within the geographic region;
generating, by the computing device, based on a plurality of factors, an action for the delivery associate to perform at the customer address, wherein the factors comprise a probability of theft associated with the customer address based on the locale theft information, route information associated with the delivery associate and a replacement value associated with the item, wherein the action comprises performing the redelivery attempt at the customer address at a later time on a day of delivery; and
sending, by the computing device, a delivery assistance response to the delivery associate device comprising an instruction to perform the action at the later time.

6. The method of claim 5, further comprising:
determining, by the computing device, a geographic region associated with customer address;
wherein the probability of theft at the customer address is based at least in part on a probability of theft within the geographic region.

7. The method of claim 5, further comprising:
receiving, by the computing device from a customer device associated with the customer address, delivery feedback information comprising theft information associated with delivery attempts performed at the customer address; and
storing, by the computing device, a customer address profile associated with the customer address, wherein the customer address profile comprises a history of theft at the customer address based at least in part on the delivery feedback information;
wherein the probability of theft associated with the customer address is based at least in part on the customer address profile.

8. The method of claim 5, wherein the action includes leaving a delivery package corresponding to the delivery package identifier unattended at a location of the customer address based at least in part on the probability of theft at the location being less than a predetermined threshold probability.

9. The method of claim 5, wherein the action includes leaving a delivery package corresponding to the delivery package identifier unattended at the customer address based at least in part on the replacement value associated with the item being less than a predetermined threshold value.

10. The method of claim 5, wherein the action includes leaving a delivery package corresponding to the delivery package identifier unattended at a location of the customer address based at least in part on the replacement value associated with the item being less than a predetermined threshold value and the probability of theft at the location being less than a predetermined threshold probability.

11. The method of claim 5, further comprising:
assigning, by the computing device, a plurality of delivery orders to the delivery associate, wherein the plurality of delivery orders correspond to respective delivery packages;
generating, by the computing device, the route information associated with the delivery associate, wherein the route information includes a delivery route for delivering the delivery packages; and
determining, by the computing device, based at least in part on the route information, a cost of the redelivery attempt at the later time by the delivery associate;
wherein the factors further comprise the cost of the redelivery attempt.

12. The method of claim 11, wherein the action includes performing the redelivery attempt at the later time is based at least in part on the cost of the redelivery attempt being less than a predetermined threshold cost.

13. The method of claim 12, further comprising:
updating, by the computing device, the route information to add the redelivery attempt to the delivery route; and
sending, by the computing device, the updated route information to the delivery associate device.

14. The method of claim 5, further comprising:
receiving, by the computing device from a plurality of additional delivery associate devices, wait time information comprising a history of time spent waiting for access to the customer address during previous delivery attempts to the customer address; and
storing, by the computing device, a customer address profile associated with the customer address, wherein the customer address profile comprises the wait time information for the customer address;
wherein the factors further comprise an estimate of a wait time at the customer address based at least in part on the customer address profile.

15. The method of claim 14, wherein the action includes at least one of:
leaving a delivery package unattended at the customer address;
waiting at the customer address for a duration of the wait time; or
delivering the delivery package to a storage facility.

16. The method of claim 5, further comprising:
receiving, by the computing device from a customer device associated with a customer, device activity information comprising a history of device usage and locations of the device during the usage; and
storing, by the computing device, a customer profile associated with the customer, wherein the customer profile comprises the device activity information;
wherein the factors further comprise an estimate of a wait time at the customer address based at least in part on the customer profile.

17. The method of claim 5, further comprising:
generating, by the computing device, a weather model to predict a weather forecast in a geographic region including the customer address;
wherein the factors further comprise a weather prediction based at least in part on the weather model.

18. One or more non-transitory computer-readable media maintaining instructions that, when executed by one or more processors, program the one or more processors to:
receive, from a delivery associate device associated with a delivery associate, a delivery assistance request that includes a delivery package identifier;
determine a customer address associated with the delivery assistance request based at least in part on the delivery package identifier;
determine an item associated with the delivery assistance request based at least in part on the delivery package identifier;
receive, from a locale database, locale theft information for a geographic region associated with the customer address, wherein the locale theft information comprises incidents of theft within the geographic region;
generate an action for the delivery associate to perform at the customer address based on a plurality of factors, wherein the factors comprise locale and customer information associated with the customer address, a probability of theft associated with the customer address based on the locale theft information, route information associated with the delivery associate and a replacement value associated with the item, wherein the action comprises performing the redelivery attempt at the customer address at a later time on a day of delivery; and
send a delivery assistance response to the delivery associate device comprising an instruction to perform the action at the later time.

19. The one or more non-transitory computer-readable media as recited in claim 18, wherein the instructions further program the one or more processors to:
receive, from a plurality of additional delivery associate devices, wait time information comprising a history of time spent waiting for access to the customer address during previous delivery attempts to the customer address; and
store a customer address profile associated with the customer address, wherein the customer address profile comprises the wait time information for the customer address;
wherein the factors further comprise an expected wait time at the customer address based at least in part on the customer address profile.

20. The one or more non-transitory computer-readable media as recited in claim 19, wherein the instructions further program the one or more processors to:
determine a threshold wait time based at least in part on the route information, and wherein the action includes waiting the expected wait time for an occupant of the customer address to arrive based at least in part on the expected wait time being less than the determined threshold wait time.
